(19) United States
(12) Patent Application Publication
(10) Pub. No.: US 2025/0077983 A1
(43) Pub. Date: Mar. 6, 2025

(54) COMPUTER-READABLE RECORDING MEDIUM STORING LEARNING PROGRAM, INFORMATION PROCESSING DEVICE, AND LEARNING METHOD

(71) Applicant: Fujitsu Limited, Kawasaki-shi (JP)

(72) Inventors: Yoshihiro OKAWA, Yokohama (JP); Hayato DAN, Yokohama (JP); Natsuki ISHIKAWA, Yamato (JP); Masatoshi OGAWA, Zama (JP)

(73) Assignee: Fujitsu Limited, Kawasaki-shi (JP)

(21) Appl. No.: 18/783,497

(22) Filed: Jul. 25, 2024

(30) Foreign Application Priority Data
Sep. 4, 2023 (JP) 2023-143184

(51) Int. Cl. G06N 20/20

(52) U.S. Cl. CPC G06N 20/20

(57) ABSTRACT

A recording medium stores a program for causing a computer to execute processing including: determining priority of a state to be used at a time of making an action for a first agent; selecting a true value or an alternative value as a value to be input to a first policy parameter according to the priority of the state; determining a first degree of influence on a constraint condition of the first agent and a third degree of influence on system-wide constraint conditions based on a second degree of influence by a second policy parameter updated by a second agent in a previous order in an update order according to a predetermined update order by using the first policy parameter; and determining a range of a policy parameter that satisfies the constraint condition according to the first degree of influence and the third degree of influence.

### CROSS-REFERENCE TO RELATED APPLICATION

This application is based upon and claims the benefit of priority of the prior Japanese Patent Application No. 2023-143184, filed on Sep. 4, 2023, the entire contents of which are incorporated herein by reference.

### FIELD

The embodiment discussed herein is related to a learning program and the like.

### BACKGROUND

In recent years, multi-agent reinforcement learning (MARL) has been known in which a plurality of agents solves a shared problem while interacting with a common environment and sequentially making decisions. In such multi-agent reinforcement learning, there is a problem that <1> the number of dimensions of an action space to be learned exponentially increases as the number of agents increases. Furthermore, there is a problem that <2> performance during and after learning is not guaranteed. For example, there is a problem that there is no way of knowing the final performance until the learning ends.

Japanese Laid-open Patent Publication No. 2009-014300, Japanese Laid-open Patent Publication No. 2020-080103, U.S. Patent Application Publication No. 2021/0200163, and Gu, Shangding, et al. “Multi-agent constrained policy optimisation” arXiv preprint arXiv: 2110.02793 (2021) are disclosed as related art.

### SUMMARY

According to an aspect of the embodiments, a non-transitory computer-readable recording medium stores a learning program for causing a computer to execute processing including: in a constrained control problem in which a plurality of agents exist, determining priority of a state to be used at a time of making an action for a first agent among the plurality of agents based on a relationship among the plurality of agents; selecting, for the first agent, a true value or an alternative value as a value to be input to a first policy parameter according to the priority of the state; determining, for the first agent, a first degree of influence on a constraint condition of the first agent and a third degree of influence on system-wide constraint conditions based on a second degree of influence by a second policy parameter updated by a second agent in a previous order in an update order according to a predetermined update order by using the first policy parameter to which the value is input; and determining a range of a policy parameter that satisfies the constraint condition according to the first degree of influence and the third degree of influence.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of a functional configuration of an information processing device according to an embodiment;

FIG. 2 is a diagram illustrating an example of priority information according to the embodiment;

FIG. 3 is a diagram illustrating images of multi-agent reinforcement learning processing according to the embodiment;

FIG. 4A is a diagram (1) illustrating an example of an overall flowchart of learning processing according to the embodiment;

FIG. 4B is a diagram (2) illustrating an example of the overall flowchart of the learning processing according to the embodiment;

FIG. 4C is a diagram (3) illustrating an example of the overall flowchart of the learning processing according to the embodiment;

FIG. 4D is a diagram (4) illustrating an example of the overall flowchart of the learning processing according to the embodiment;

FIG. 5 is a diagram illustrating an example of an overall flowchart of prediction processing according to the embodiment;

FIG. 6 is a diagram illustrating an example in which multi-agent reinforcement learning according to the embodiment is applied;

FIG. 7A is a diagram (1) illustrating an example of priority determination according to the embodiment;

FIG. 7B is a diagram (2) illustrating an example of the priority determination according to the embodiment;

FIG. 8 is a diagram illustrating an example of a method of setting a part of states as alternative values according to priority of the states;

FIG. 9A is a diagram (1) illustrating an example of an application result of the multi-agent reinforcement learning according to the embodiment;

FIG. 9B is a diagram (2) illustrating an example of the application result of the multi-agent reinforcement learning according to the embodiment;

FIG. 10 is a diagram illustrating an example of a computer that executes a learning program;

FIG. 11 is a diagram illustrating a reference example of the multi-agent reinforcement learning processing;

FIG. 12A is a diagram (1) illustrating an image of the multi-agent reinforcement learning processing in consideration of system-wide constraint conditions;

FIG. 12B is a diagram (2) illustrating an image of the multi-agent reinforcement learning processing in consideration of the system-wide constraint conditions;

FIG. 13A is a diagram (1) illustrating an example of an overall flowchart of the multi-agent reinforcement learning processing in consideration of the system-wide constraint conditions;

FIG. 13B is a diagram (2) illustrating an example of the overall flowchart of the multi-agent reinforcement learning processing in consideration of the system-wide constraint conditions;

FIG. 13C is a diagram (3) illustrating an example of the overall flowchart of the multi-agent reinforcement learning processing in consideration of the system-wide constraint conditions; and

FIG. 14 is a diagram for describing a problem of the multi-agent reinforcement learning processing in consideration of the system-wide constraint conditions.

### DESCRIPTION OF EMBODIMENTS

Here, there has been disclosed a method for constrained multi-agent reinforcement learning involving a plurality of agents, in which a policy of each agent that maximizes a reward common to all agents is learned while satisfying safe constraint conditions specific to each agent. In such a method, by causing each agent to learn its own policy, it is possible to avoid an exponential increase in the dimensions of an action space to be learned. For example, in such a method, it is possible to avoid the problem of <1> that the number of dimensions of the action space to be learned exponentially increases as the number of agents increases.

However, the method in the related art has a problem that it is not possible to perform learning in consideration of system-wide constraint conditions that depend on results of actions of the plurality of agents. As a result, it may be said that there is the problem of <2> that the performance during and after learning is not guaranteed.

In one aspect, an object of an embodiment is to perform learning in consideration of system-wide constraint conditions in constrained multi-agent reinforcement learning.

Hereinafter, an embodiment of a learning program, an information processing device, and a learning method disclosed in the present application will be described in detail with reference to the drawings. Note that the present disclosure is not limited by the embodiment.

First, one method for constrained multi-agent reinforcement learning involving a plurality of agents will be described. In the multi-agent reinforcement learning mentioned herein, a plurality of agents solves a shared problem while interacting with a common environment and sequentially making decisions. For example, in the constrained multi-agent reinforcement learning, each agent learns a policy for minimizing (or maximizing) a “reward” (objective function) while observing current “states” and satisfying “constraint conditions” by using a series of “actions” as keys. The “constraint conditions” mentioned herein refer to conditions for guaranteeing performance. As an example of the constrained multi-agent reinforcement learning, learning of an algorithm for wave transmission stop control of each base station (BS) in a communication network in each area so as to minimize a total sum of power consumption of all BSs while keeping a certain or higher average satisfaction level of all users attached to the BS is exemplified. The BS mentioned herein is an example of the agent. Keeping a certain or higher average satisfaction level of all the users is an example of the “constraint conditions”. A time point, an amount of grid demand, a load of a BS at a previous time point, power consumption of the BS at the previous time point, and the like are examples of the “states”. The total sum of power consumption of all the BSs is an example of the “reward” (objective function). Whether or not to stop wave transmission of the BS (turning the BS on/off) is an example of the “actions”.

In one method of multi-agent reinforcement learning processing, each agent learns its own policy that maximizes a reward common to all the agents while satisfying safe constraint conditions specific to the agent. In such a method, each agent learns the policy and accordingly each agent grasps its actions, which makes it possible to avoid an exponential increase in dimensions of an action space.

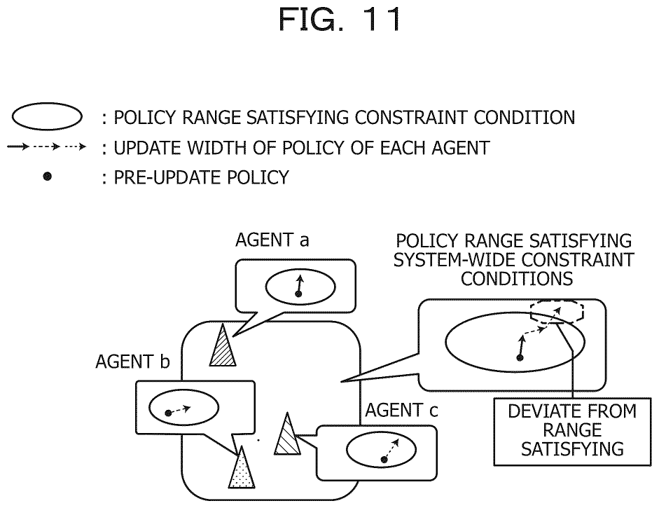

However, such a method has a problem that it is not possible to perform learning in consideration of system-wide constraint conditions that depend on results of actions of the plurality of agents. Such a problem will be described. FIG. 11 is a diagram illustrating a reference example of the multi-agent reinforcement learning processing. Note that FIG. 11 illustrates a case where there are three agents.

As illustrated in FIG. 11, in the multi-agent reinforcement learning processing, each agent updates its own policy so as to satisfy its own specific constraint condition. Here, in one learning step, an agent a calculates an update width based on the pre-update policy so as to satisfy its own specific constraint condition, and updates the policy by the calculated update width. In the same learning step, each of agents b and c similarly calculates an update width based on the pre-update policy so as to satisfy its own specific constraint condition, and updates the policy by the calculated update width.

However, with the method in which each agent updates its own policy so as to satisfy its own specific constraint condition, the system-wide constraint conditions are not necessarily satisfied. For example, there is a case where the post-update policy of a certain agent may deviate from a policy range satisfying the system-wide constraint conditions. For example, with such a method, it is not possible to perform learning in consideration of the system-wide constraint conditions that depend on results of actions of the plurality of agents.

Thus, there is a conceivable approach including: calculating degrees of influence on both of the constraint conditions specific to each agent and each of system-wide constraint conditions after update of the policy of each agent; and imposing, on the update width of the policy in each learning step, a limitation according to the degrees of influence.

However, in the case where the respective agents sequentially update their policies, even when a preceding agent in the update order updates the policy so as to satisfy the constraint conditions, the constraint conditions may not be satisfied due to update by a subsequent agent in the update order. For this reason, it is needed to appropriately update the policy of each agent, but there is no specific and quantitative method for the update method.

Thus, the constrained multi-agent reinforcement learning processing capable of learning for appropriately updating the policy of each agent in consideration of system-wide constraint conditions will be described.

### [Images of Multi-Agent Reinforcement Learning Processing]

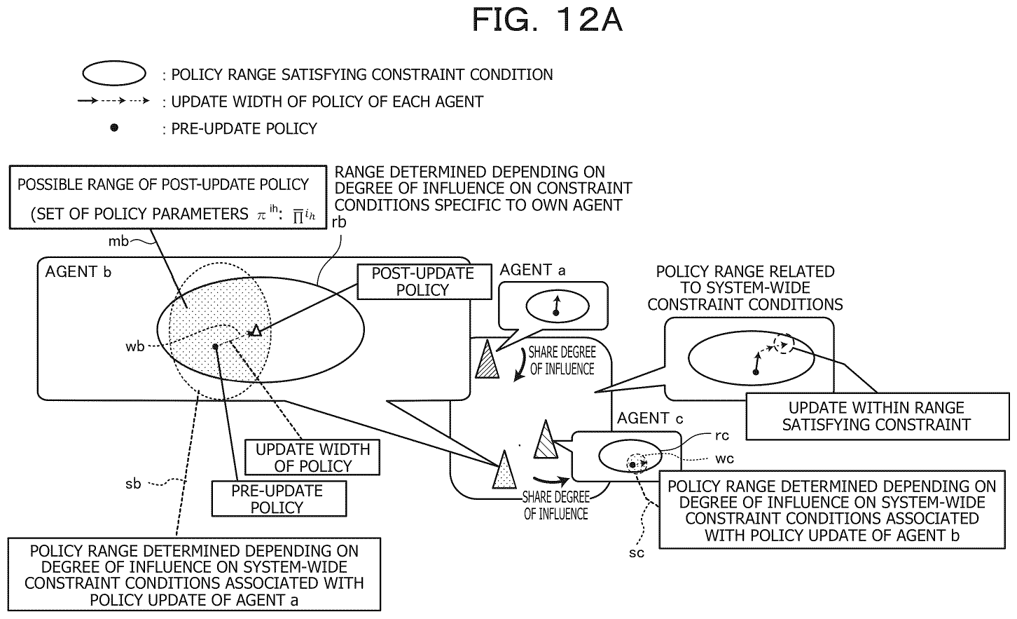

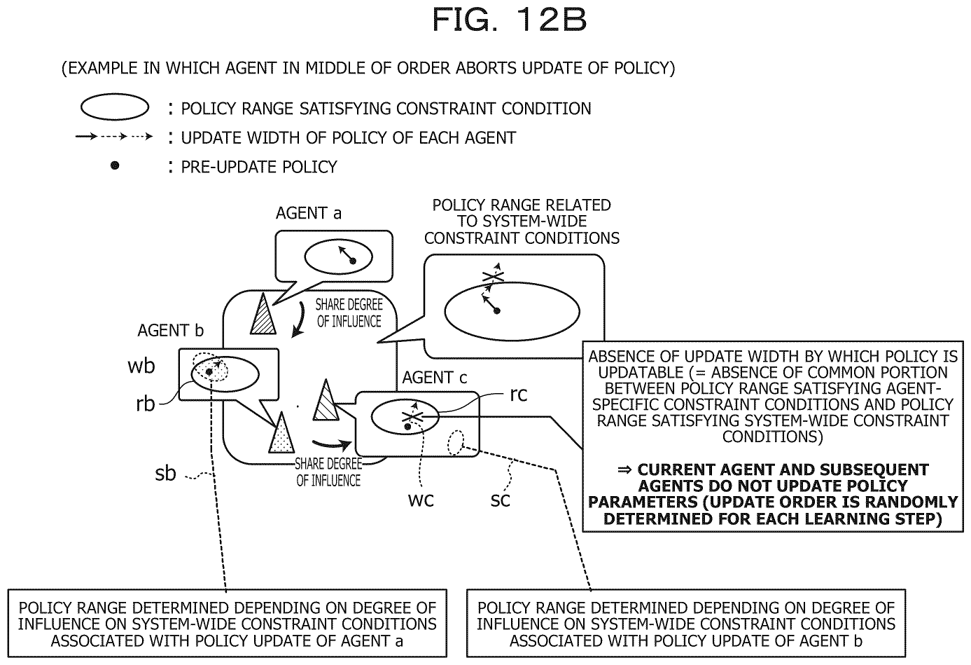

Images of the multi-agent reinforcement learning processing in consideration of the system-wide constraint conditions will be described with reference to FIGS. 12A and 12B. FIGS. 12A and 12B are diagrams illustrating the images of the multi-agent reinforcement learning processing in consideration of the system-wide constraint conditions. Note that it is assumed that there are three agents a, b, and c. Additionally, it is assumed that an information processing device randomly determines a, b, and c as a policy parameter update order of the respective agents. Additionally, it is assumed that a degree of influence by a post-update policy parameter of the agent a is caused to be shared with the next agent b in the update order.

Then, the information processing device calculates a degree of influence on constraint conditions specific to the next agent b in the update order, and a degree of influence on system-wide constraint conditions in which the degree of influence by the post-update policy parameter of the preceding agent a in the update order is shared. For example, the information processing device calculates the degree of influence on the constraint conditions specific to the agent b, and calculates the degree of influence on the system-wide constraint conditions by sharing the degree of influence of the post-update policy parameter of the agent a. Then, the information processing device determines whether or not an update width of a policy parameter of the own agent b is within a range determined depending on the degree of influence on the constraint conditions specific to the own agent b and the degree of influence on the system-wide constraint conditions. For example, the information processing device determines whether or not the possible range of the post-update policy parameter of the own agent b is within the range determined depending on the degree of influence on the constraint conditions specific to the own agent b and the degree of influence on the system-wide constraint conditions.

Here, the possible range of the post-update policy parameter of each agent is calculated based on, for example, Expression (1).

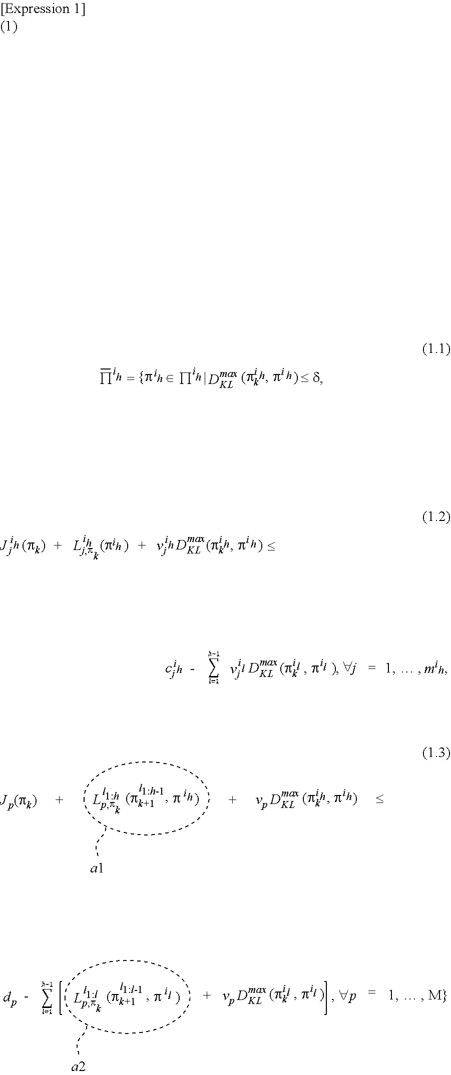

A left side of Expression (1) indicates a set of policy parameters n^{ih} satisfying agent-specific constraint conditions of an agent iₕ and system-wide constraint conditions. For example, the left side of Expression (1) indicates the possible range of the post-update policy parameter. A right side of Expression (1) includes (1.1), (1.2), and (1.3).

(1.1) is a condition to avoid increasing a change from a policy parameter n^{ih} in a previous learning step k in the own agent iₕ. Description of variables in (1.1) is as follows. The variable n^{ih} indicates a post-update policy parameter of the agent iₕ. The variable nₖ^{ih} indicates a pre-update policy parameter of the agent iₕ (in the learning step k). The variable D_{kL}^{max} indicates a maximum value of Kullback-Leibler divergence between the two policy parameters. The variable δ indicates an upper limit related to the change between the pre-update and post-update policy parameters.

(1.2) is a condition for satisfying a constraint condition j specific to each agent iₕ. Description of variables in (1.2) is as follows. The variable Jⱼ^{ih}(⋅) and the variable cⱼ^{ih} indicate a cost function and its upper limit value related to the constraint condition j specific to the agent iₕ. The variable L^{ih}_{j,nk}(n^{ih}) indicates a degree of influence on the specific constraint condition j by the post-update policy parameter of the agent iₕ. The variable vⱼ^{ih} indicates a coefficient related to a change in the constraint condition j specific to the agent iₕ between the pre-update and post-update policy parameters. The variable m^{ih} indicates the number of constraint conditions specific to the agent iₕ.

(1.3) is a condition for satisfying a system-wide constraint condition p, and includes a degree of influence shared from the preceding agent in the update order. Description of variables in (1.3) is as follows. The variable Jₚ(⋅) and the variable dₚ indicate a cost function and its upper limit value related to the system-wide constraint condition p. The variable Πₖ₊₁^{i1:h-1} indicates post-update policy parameters of agents (i₁, . . . , iₕ₋₁) preceding to the agent iₕ in the update order. The variable L indicated by a reference sign a1 indicates a degree of influence on the system-wide constraint condition p by the post-update policy parameters of the agent iₕ and the agents (i₁, . . . , iₕ₋₁) preceding to the agent iₕ in the update order. The variable L, I=1, . . . , h−1 indicated by a reference sign a2 indicates a degree of influence on the system-wide constraint condition p by the post-update policy parameters of the agent preceding to the agent iₕ in the update order, the degree shared from the agent preceding to the agent iₕ in the update order. The variable vₚ indicates a coefficient related to a change in the system-wide constraint condition p between the pre-update and post-update policy parameters. The variable M indicates the number of system-wide constraint conditions.

For example, the information processing device determines whether or not the update width of the policy parameter of the own agent is within the range determined depending on the degree of influence on the constraint conditions specific to the own agent by using (1.1) and (1.2) in Expression (1). Then, the information processing device determines whether or not the update width of the policy parameter of the own agent is within the range determined depending on the degree of influence on the system-wide constraint conditions by using Expression (1.3). For example, the information processing device determines whether or not the update width of the policy parameter of the own agent is within the range determined depending on the degree of influence on the constraint conditions specific to the own agent and the degree of influence on the system-wide constraint conditions by using Expression (1) including (1.1) to (1.3).

Here, as illustrated in FIG. 12A, the range determined depending on the degree of influence on the constraint conditions specific to the own agent b is a range indicated by a reference sign rb. Such a range is represented by both the left and right sides of (1.1) and (1.2) in Expression (1). Furthermore, the range determined depending on the degree of influence on the system-wide constraint conditions, in which the degree of influence by the post-update policy parameter of the agent a is shared, is a range indicated by a reference sign sb. Such a range is represented by both the left and right sides of (1.3) in Expression (1). Additionally, the possible range of the post-update policy parameter of the own agent b is a range indicated by a reference sign mb. Such a range is represented by both the left and right sides of Expression (1), and corresponds to a set of post-update policy parameters nⁱₕ that may be taken by the agent b. For example, the range indicated by the reference sign mb is an overlap portion between the range indicated by the reference sign rb and the range indicated by the reference sign sb. When there is at least one post-update policy parameter in the range indicated by the reference sign mb, the possible range of the post-update policy parameter of the agent b exists, and the update width of the policy parameter exists. Note that, when the post-update policy parameter is represented by a certain point in the range indicated by the reference sign mb, the update width mentioned herein refers to a line segment joining the pre-update policy parameter and the certain point.

In FIG. 12A, since the update width of the policy parameter of the own agent b is within the range (mb) determined depending on the degree of influence on the constraint conditions specific to the own agent b and the degree of influence on the system-wide constraint conditions, the information processing device performs the following processing. The information processing device updates the policy parameter of the own agent by the existing update width. Then, the information processing device causes the degree of influence by the post-update policy parameter to be shared with the next agent in the update order.

Then, the information processing device calculates the degree of influence on the constraint conditions specific to the next agent c in the update order, and the degree of influence on the system-wide constraint conditions in which the degree of influence by the post-update policy parameter of the preceding agent b in the update order is shared. For example, the information processing device calculates the degree of influence on the constraint conditions specific to the agent c, and calculates the degree of influence on the system-wide constraint conditions by sharing the degree of influence of the post-update policy parameter of the agent b. Then, the information processing device determines whether or not the update width of the policy parameter of the own agent c is within a range determined depending on the degree of influence on the constraint conditions specific to the own agent c and the degree of influence on the system-wide constraint conditions. For example, the information processing device determines whether or not the possible range of the post-update policy parameter of the own agent c is within the range determined depending on the degree of influence on the constraint conditions specific to the own agent c and the degree of influence on the system-wide constraint conditions.

Here, as illustrated in FIG. 12A, the range determined depending on the degree of influence on the constraint conditions specific to the own agent c is a range indicated by a reference sign rc. Furthermore, the range determined depending on the degree of influence on the system-wide constraint conditions, in which the degree of influence by the post-update policy parameter of the agent b is shared, is a range indicated by a reference sign sc. Additionally, the possible range of the post-update policy parameter of the own agent c is an overlap portion between the range indicated by the reference sign rc and the range indicated by the reference sign sc. When there is at least one post-update policy parameter in such a range, the possible range of the post-update policy parameter of the agent c exists, and the update width of the policy parameter exists.

In FIG. 12A, since the update width of the policy parameter of the own agent c is within the range determined depending on the degree of influence on the constraint conditions specific to the own agent c and the degree of influence on the system-wide constraint conditions, the information processing device performs the following processing. For example, the information processing device updates the policy parameter of the own agent by the existing update width.

As a result, the information processing device may update the policy parameter of each agent within a range satisfying the system-wide constraint conditions. As a result, the information processing device may perform learning in consideration of the system-wide constraint conditions that depend on results of actions of the plurality of agents.

FIG. 12B illustrates an example of a case where an agent in the middle of the order aborts the update of the policy parameter. As illustrated in FIG. 12B, in the information processing device, an update width wb of the policy parameter of the agent b is within a range (rb) determined depending on the degree of influence on the constraint conditions specific to the agent b, and the update width wb of the policy parameter of the agent b is within a range (sb) determined depending on the degree of influence on the system-wide constraint conditions. For example, in the information processing device, the update width wb of the policy parameter of the agent b is within the policy range (sb) determined depending on the degree of influence on the system-wide constraint conditions associated with the policy update of the preceding agent a in the update order. For this reason, the information processing device updates the policy parameter of the agent b, and causes the degree of influence by the post-update policy parameter to be shared with the next agent c in the update order.

Next, the information processing device calculates the degree of influence on the constraint conditions specific to the agent c, and calculates the degree of influence on the system-wide constraint conditions by sharing the degree of influence of the post-update policy parameter of the agent b. Then, the information processing device determines whether or not the update width of the policy parameter of the own agent c is within a range determined depending on the degree of influence on the constraint conditions specific to the own agent c and the degree of influence on the system-wide constraint conditions. For example, the information processing device determines whether or not the possible range of the post-update policy parameter of the own agent c is within the range determined depending on the degree of influence on the constraint conditions specific to the own agent c and the degree of influence on the system-wide constraint conditions. Here, an update width wc of the policy parameter of the agent c is within a range (rc) determined depending on the degree of influence on the constraint conditions specific to the agent c. However, the update width wc of the policy parameter of the agent c is not within a range (sc) determined depending on the degree of influence on the system-wide constraint conditions. The overlapping ranges (rc, sc) do not have any common portion of the update width. For this reason, the information processing device does not update the policy parameter of the agent c. Furthermore, the information processing device does not update the policy parameters of the subsequent agents in the update order.

This is because of absence of an update width by which the policy parameter is updatable. For example, this is because an overlap portion between the range of the policy parameter satisfying the agent-specific constraint conditions and the range of the policy parameter satisfying the system-wide constraint conditions does not have a common portion of the update width. As a result, by avoiding the update of the policy parameters of the agent c and the subsequent agents, the information processing device may guarantee that the constraint conditions specific to each agent and also the system-wide constraint conditions that depend on results of actions of the plurality of agents will be satisfied during and after the learning.

### [Flowchart of Multi-Agent Reinforcement Learning Processing]

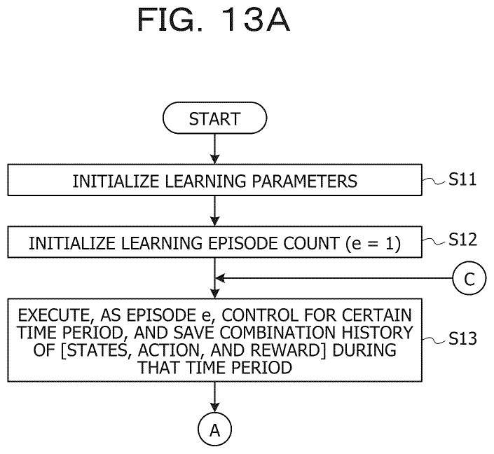

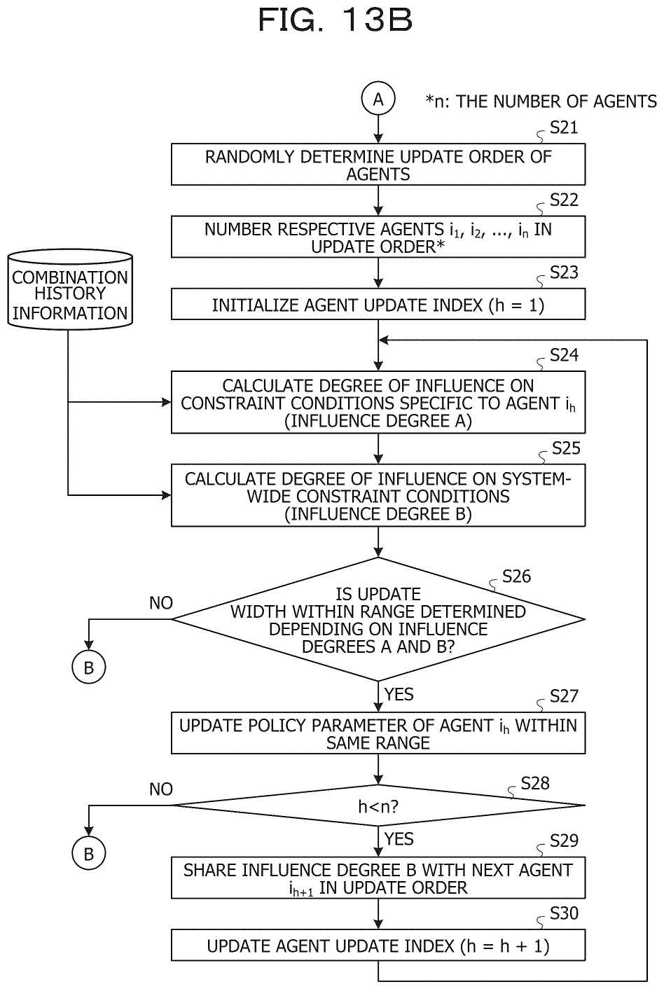

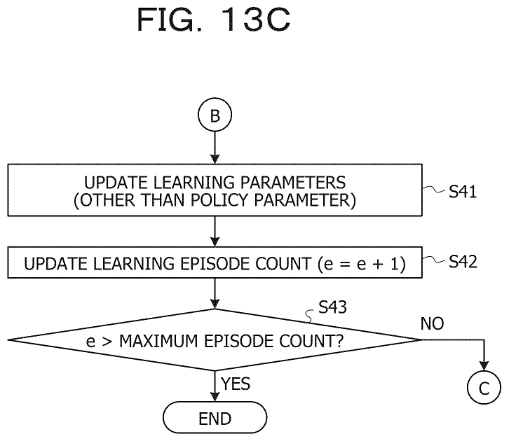

Next, an example of an overall flowchart of the multi-agent reinforcement learning processing in consideration of the system-wide constraint conditions will be described. FIGS. 13A to 13C are diagrams illustrating an example of the overall flowchart of the multi-agent reinforcement learning processing in consideration of the system-wide constraint conditions.

As illustrated in FIG. 13A, the information processing device initializes learning parameters (step S11). The information processing device initializes a learning episode count (step S12). Here, the information processing device sets the learning episode count “1” in a variable e. As an episode e, the information processing device executes control for a certain time period, and saves a combination history of states, an action, and a reward for each agent during that time period in combination history information (step S13). Note that the combination history information mentioned herein refers to history information that stores a combination of states, an action, and a reward for each agent in a learning episode.

As illustrated in FIG. 13B, the information processing device randomly determines an update order of agents (step S21). The information processing device numbers the respective agents i₁, i₂, . . . , iₙ in the update order, for example (step S22). Here, it is assumed that n is the number of agents. The information processing device initializes an agent update index h (step S23). Here, the information processing device sets “1” in the variable h.

By using the combination history information, the information processing device calculates a degree of influence on constraint conditions specific to the agent iₕ (influence degree A) (step S24). By using the combination history information, the information processing device calculates a degree of influence on system-wide constraint conditions (influence degree B) (step S25). For example, the information processing device calculates the influence degree B on the system-wide constraint conditions based on the degree of influence shared from the preceding agent in the update order.

The information processing device determines whether or not the update width of the policy parameter of the agent iₕ is within a range determined depending on the influence degree A and the influence degree B (step S26). When determining that the update width of the policy parameter of the agent iₕ is not within the range determined depending on the influence degree A and the influence degree B (step S26; No), the information processing device performs the following processing. For example, the information processing device proceeds to step S41 without updating the policy parameter of the agent iₕ and the policy parameters of the subsequent agents.

On the other hand, when determining that the update width of the policy parameter of the agent iₕ is within the range determined depending on the influence degree A and the influence degree B (step S26; Yes), the information processing device performs the following processing. For example, the information processing device updates the policy parameter of the agent iₕ within the range determined depending on the influence degree A and the influence degree B (step S27).

Then, the information processing device determines whether or not the agent update index h is smaller than the number n of the agents (step S28). When determining that h is equal to or larger than n (step S28; No), the information processing device proceeds to step S41 since the processing corresponding to the number of agents is ended.

When determining that h is smaller than n (step S28; Yes), the information processing device causes the influence degree B to be shared with the next agent iₕ₊₁ in the update order (step S29). Then, the information processing device updates the agent update index h by 1 (step S30). Then, the information processing device proceeds to step S24 to execute the update processing on the next agent iₕ₊₁ in the update order.

As illustrated in FIG. 13C, in step S41, the information processing device updates the learning parameters other than the policy parameter (step S41). The information processing device updates the learning episode count by 1 (step S42).

Then, the information processing device determines whether or not the learning episode count e is larger than a maximum episode count (step S43). When determining that the learning episode count e is not larger than the maximum episode count (step S43; No), the information processing device proceeds to step S13 to perform processing on the next learning episode.

On the other hand, when determining that the learning episode count e is larger than the maximum episode count (step S43; Yes), the information processing device ends the multi-agent reinforcement learning processing.

Note that, in FIGS. 13A to 13C, when the episode e is updated, the information processing device executes control for a certain time period, and saves a combination history of states, an action, and a reward for each agent during that time period in the combination history information. Then, it has been described that the information processing device uses this combination history information to update the policy of each agent in the updated episode e. However, the information processing device is not limited to this, and when the episode e is updated, the information processing device may update the policy of each agent in the updated episode e by using the combination history already saved in the combination history information.

### <Problem of Learning Processing>

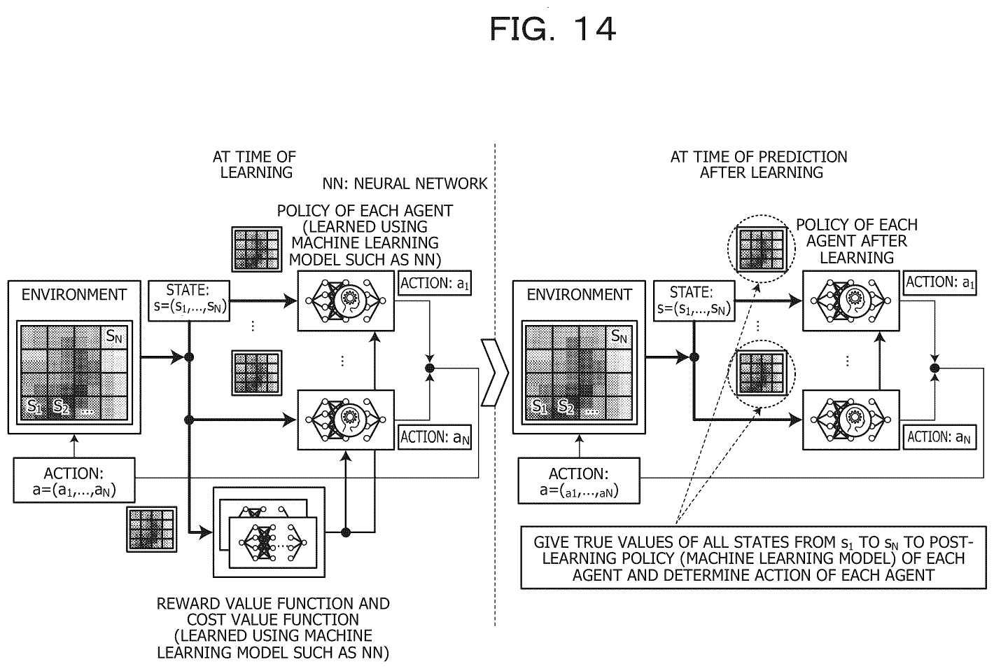

Meanwhile, in the multi-agent reinforcement learning processing in consideration of the system-wide constraint conditions, each agent inputs true values of all states obtained by executing control for a certain time period and learns a policy. Then, even in a case where an action is determined (predicted) using each policy after learning, each agent determines (predicts) an action by inputting the true values of all the states to the policy after learning of each agent. Therefore, in the multi-agent reinforcement learning processing in consideration of the system-wide constraint conditions, there is a problem that it is needed to aggregate the true values of all the states into each agent even in the prediction after learning, and a cost of aggregating information regarding the states of all the agents into each agent increases. For example, there is a problem that it is needed to exchange the true values of the states among all the agents, and the cost of exchanging the information regarding the states among all the agents increases. Such a problem will be described with reference to FIG. 14.

FIG. 14 is a diagram for describing the problem of the multi-agent reinforcement learning processing in consideration of the system-wide constraint conditions. A left diagram in FIG. 14 represents a flow of the processing at the time of learning, and a right diagram in FIG. 14 represents a flow of the processing at the time of prediction after the learning.

As illustrated in the left diagram in FIG. 14, in the processing at the time of learning, the information processing device acquires N states s and actions a as an environment, inputs the acquired environment and rewards, and learns a policy (machine learning model) of each agent in order to determine an action of each agent. The N states s and actions a acquired as the environment mentioned herein indicate, for example, (s₁, . . . , s_{N}) and (a₁, . . . , a_{N}), and mean states and actions of objects to which the respective agents add actions. As an example, a state and an action of an object to which an agent 1 adds an action indicate s₁ and a₁. A state and an action of an object to which an agent 2 adds an action indicate s₂ and a₂. Furthermore, the rewards indicate a reward value function and a cost value function, and indicate objective functions using the state of each agent.

The N states s input to the processing at the time of learning are true values of the states acquired by each agent. For example, in the processing at the time of learning, the information processing device inputs the true values of the states acquired by each agent, and learns a policy (machine learning model) of each agent in order to determine an action of each agent. As an example, in order to learn a policy (machine learning model) of the agent 1, the information processing device needs to input the true values of the states acquired by each agent.

Furthermore, as illustrated in the right diagram in FIG. 14, in the processing at the time of prediction after the learning, the information processing device acquires the N states s as the environment, inputs the acquired environment, and determines (predicts) an action of each agent using the policy of each agent after the learning. The N states s input at the time of prediction after the learning are true values of the states acquired from each agent. For example, also in the processing at the time of prediction after the learning, the true values of all the states acquired by each agent are given, and an action of each agent is determined. Therefore, in the multi-agent reinforcement learning processing in consideration of the system-wide constraint conditions, there is a problem that it is needed to aggregate the true values of all the states into each agent even at the time of prediction after the learning, and a cost of aggregating information regarding the states of all the agents into each agent increases. For example, there is a problem that it is needed to exchange the true values of the states among all the agents, and the cost of exchanging the information regarding the states among all the agents increases.

Thus, in the following embodiment, constrained multi-agent reinforcement learning processing capable of performing learning in consideration of system-wide constraint conditions while reducing the number of states to which true values are given will be described.

### Embodiment

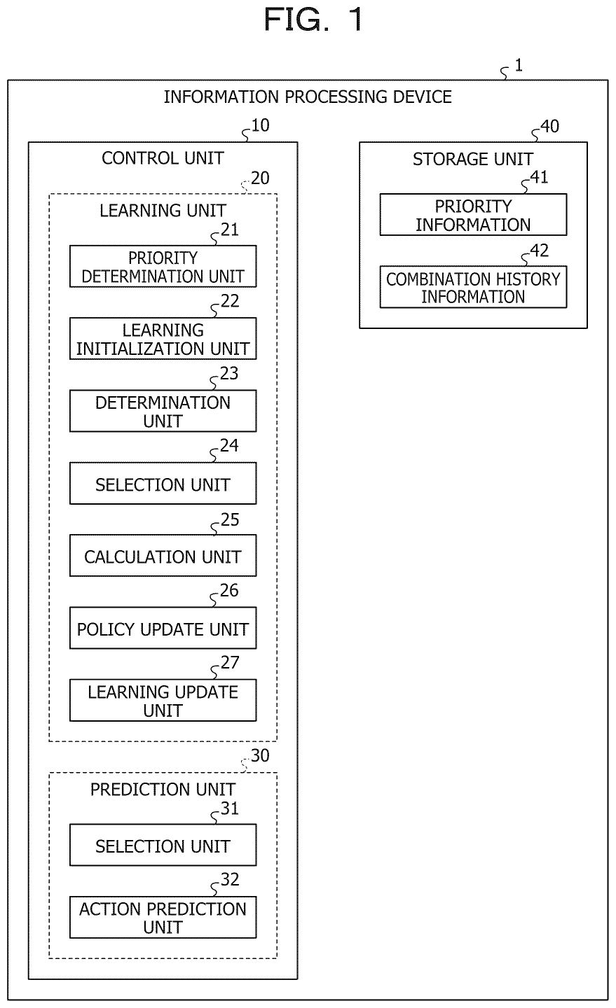

FIG. 1 is a block diagram illustrating an example of a functional configuration of an information processing device according to the embodiment. An information processing device 1 illustrated in FIG. 1 performs constrained multi-agent reinforcement learning processing capable of performing learning in consideration of system-wide constraint conditions. In addition, the information processing device 1 determines priority of a state used for action determination for each agent, selects a true value or an alternative value as a value of a state to be input to a policy of each agent according to the priority, and updates the policy of each agent. A method of updating the policy is the same as that of the multi-agent reinforcement learning processing in consideration of the system-wide constraint conditions. For example, only in a case where each agent calculates degrees of influence on its own specific constraint condition and the system-wide constraint conditions in order and an update width exists within a range determined by the calculated degrees of influence, the information processing device 1 performs policy update within this range. Then, in a case where the policy is updated, the information processing device 1 causes the degree of influence of the post-update policy on the system-wide constraint conditions to be shared with the next agent in the update order. The policy mentioned herein includes a policy parameter.

The information processing device 1 includes a control unit 10 and a storage unit 40. The control unit 10 includes a learning unit 20 and a prediction unit 30. Furthermore, the storage unit 40 includes priority information 41 and combination history information 42. Note that a priority determination unit 21 is an example of a priority determination unit. A selection unit 24 is an example of a selection unit. A policy update unit 26 is an example of a determination unit.

The combination history information 42 is history information that stores a combination of states, an action, and a reward for each agent in a learning episode. The learning episode mentioned herein means a section from a start to an end of an action for an environment given to the reinforcement learning. For example, the states, the action, and the reward in the case of learning an algorithm for wave transmission stop control of each BS (agent) are as follows. The states are information indicating a time point, an amount of grid demand, a load of the BS at a previous time point, power consumption of the BS at the previous time point, and the like. The action is information indicating on/off (whether or not to stop wave transmission) of the BS. The reward is information indicating a total sum of power consumption of all the BSs.

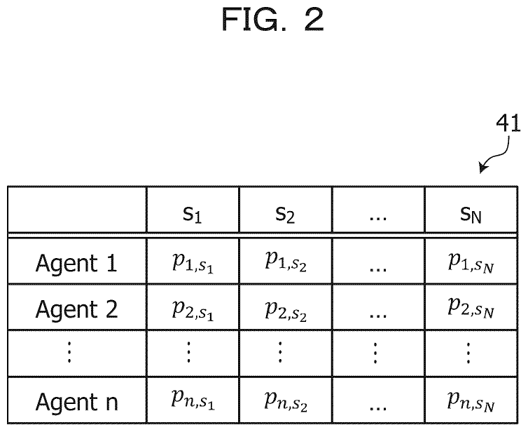

The priority information 41 is information that stores priority of a state used when an action is determined for each agent. Priority of a state for one agent represents priority (importance) of a state obtained from a relationship with another agent. Here, an example of the priority information 41 will be described with reference to FIG. 2.

FIG. 2 is a diagram illustrating an example of the priority information according to the embodiment. As illustrated in FIG. 2, the priority information 41 stores priority of a state used for action determination of an agent. For example, priority pᵢ of a state for an agent i includes priority pᵢₛⱼ (j=1, 2, . . . , N) of N states. The N states mean states of the respective objects to which the respective agents add actions.

As an example, in a first row, priority pᵢₛⱼ of a state sⱼ (j=1, . . . , N) used by an agent 1 for action determination is stored. For example, pᵢₛⱼ represents the priority of the state sⱼ used for the action determination of the agent i. For example, the priority pᵢₛⱼ of the state sⱼ for the agent i represents priority (importance) of the state sⱼ obtained from a relationship with another agent.

Returning to FIG. 1, the learning unit 20 includes the priority determination unit 21, a learning initialization unit 22, a determination unit 23, the selection unit 24, a calculation unit 25, the policy update unit 26, and a learning update unit 27.

The priority determination unit 21 determines priority of a state used when an action is determined for each agent. For example, the priority determination unit 21 specifies a relationship between agents by using information collected in advance or by a preliminary experiment. Then, the priority determination unit 21 uses the relationship between the agents to determine priority of the respective states to be used when actions of the agents are determined. The relationship between the agents mentioned herein means, for example, an index indicating how much there is a relationship between the agents. As examples of the index, importance by a decision tree algorithm, a correlation coefficient between the agents, and the like are exemplified. Then, the priority determination unit 21 stores the priority of the respective states in the priority information 41 in association with the agents.

As an example, the priority determination unit 21 performs learning according to the decision tree algorithm using input information (states and action) at a time point t and output information (states) at a time point t+1 of each agent, which are collected in advance. Then, the priority determination unit 21 specifies a relationship between the agents using a learned decision tree, and calculates importance (priority) of a state of each object to which each agent adds an action using the specified relationship between the agents.

Note that, as the decision tree algorithm that is a method of obtaining importance (priority) of a state, as an example, Random Forest, XGBoost, and the like are exemplified. Furthermore, the method of obtaining the importance (priority) of the state is not limited to the decision tree algorithm, and a correlation function between the agents may be used. Furthermore, as a value used as the importance (priority) of the state, Permutation importance or Feature importance is exemplified in a case where the method is the decision tree algorithm. Furthermore, in a case where the method is the correlation function between the agents, the value used as the importance (priority) of the state may be an absolute value of the correlation coefficient. Moreover, in a case where the method is the correlation function between the agents, the value used as the importance (priority) of the state may be an absolute value of the correlation coefficient and a p value of an uncorrelated test.

Furthermore, in an example, the priority determination unit 21 calculates the relationship between the agents and the priority of the state as the same, but may separate them from each other. For example, the priority determination unit 21 calculates the correlation coefficient between the agents as the relationship between the agents using data collected in advance. In addition, the priority determination unit 21 learns Random Forest using the input information (states and action) at the time point t and the output information (states) at the time point t+1 of each agent collected in advance. Then, using importance of the learned Random Forest, the priority determination unit 21 may calculate priority of a state of an object to which an agent having a high calculated correlation coefficient adds an action.

The learning initialization unit 22 initializes data to be used for the learning. For example, the learning initialization unit 22 initializes learning parameters to be used in the reinforcement learning. Furthermore, the learning initialization unit 22 initializes a learning episode to be used in the reinforcement learning. Furthermore, the learning initialization unit 22 acquires a combination history of states, an action, and a reward for a certain time period in a current learning episode for each agent, and saves the combination history in the combination history information 42.

The determination unit 23 randomly determines a policy parameter update order of the respective agents. As a result, the determination unit 23 makes it possible to evenly update the policy parameters of each agent.

The selection unit 24 selects a true value or an alternative value for a value of a state to be input to its own policy parameter according to the priority information 41 for its own agent according to the determined update order. For example, the selection unit 24 acquires the priority pᵢₛⱼ (j=1, . . . , N) of the state sⱼ corresponding to its own agent i from the priority information 41. Then, the selection unit 24 compares the priority pᵢₛⱼ with a predetermined threshold, and when the priority pᵢₛⱼ is equal to or larger than the threshold, acquires a true value of the state sⱼ from the combination history information 42, and when the priority pᵢₛⱼ is less than the threshold, changes the state sⱼ to an alternative value. The selection unit 24 generates the state sⱼ (j=1, . . . , N) corresponding to its own agent i.

Note that it is sufficient that the threshold is determined as follows. As an example, in a case where a value used as the priority of the state is importance according to the decision tree algorithm, 1/10 of a minimum value of importance of a plurality of elements included in the state of the object to which the action of each agent is to be added may be set as the threshold, and a true value may be given in the case of equal to or larger than the threshold. As another example, in a case where the value used as the priority of the state is the absolute value of the correlation coefficient, when the absolute value of the correlation coefficient with the state of the object to which each agent adds an action is equal to or larger than 0.2 (or 0.4), a true value may be given. For example, it is sufficient that 0.2 (or 0.4) is set as the threshold. As another example, in a case where the value used as the priority of the state is the absolute value of the correlation coefficient or the p value of the uncorrelated test, when the absolute value of the correlation coefficient with the state of the object to which each agent adds an action is equal to or larger than 0.2 (or 0.4) and the p value of the uncorrelated test is less than a superiority level 0.05, a true value may be given. In such a case, it is sufficient that 0.2 and 0.05 are set as the thresholds.

Furthermore, as an example, it is sufficient that the alternative value is an average value of the states. Furthermore, as another example, the alternative value may be a median value, a predicted value, an initial state, an equilibrium point, or the like of the states. Furthermore, as another example, the alternative value may be “0”.

The calculation unit 25 calculates, according to the determined update order, the degree of influence on the constraint conditions specific to the own agent and the degree of influence on the system-wide constraint conditions associated with the policy update of the preceding agent in the update order. For example, the calculation unit 25 calculates the degree of influence on the constraint conditions specific to the own agent i according to the update order determined by the determination unit 23. Then, the calculation unit 25 calculates the degree of influence on the system-wide constraint conditions in which the degree of influence by the post-update policy parameter of a preceding agent i−1 in the update order is shared. Note that the calculation unit 25 calculates each degree of influence using the state sⱼ (j=1, . . . , N) corresponding to its own agent i and the combination history information 42.

The policy update unit 26 updates the policy parameter of the own agent in a case where the update width of the policy parameter of the own agent is within a range determined depending on the degree of influence on the constraint conditions specific to the own agent and the degree of influence on the system-wide constraint conditions. The update width mentioned herein refers to a width of update from the pre-update policy parameter to the post-update policy parameter. For example, in a case where a possible range of the post-update policy parameter of the own agent is within the range determined depending on the degree of influence on the constraint conditions specific to the own agent and the degree of influence on the system-wide constraint conditions, the policy update unit 26 updates the policy parameter of the own agent within the range. The possible range of the post-update policy parameter is calculated based on, for example, Expression (1).

For example, the policy update unit 26 determines whether or not the update width of the policy parameter of the own agent is within the range determined depending on the degree of influence on the constraint conditions specific to the own agent, in (1.1) and (1.2) in Expression (1). Then, the policy update unit 26 determines whether or not the update width of the policy parameter of the own agent is within the range determined depending on the degree of influence on the system-wide constraint conditions, in Expression (1.3). For example, the policy update unit 26 determines whether or not the update width of the policy parameter of the own agent is within the range determined depending on the degree of influence on the constraint conditions specific to the own agent and the degree of influence on the system-wide constraint conditions, in Expression (1) including (1.1) to (1.3).

Then, when determining that the update width of the policy parameter of the own agent is within the range determined depending on the degree of influence on the constraint conditions specific to the own agent and the range determined depending on the degree of influence on the system-wide constraint conditions, the policy update unit 26 performs the following processing. For example, the policy update unit 26 updates the policy parameter of the own agent by the existing update width. As a result, the policy update unit 26 may perform learning in consideration of the system-wide constraint conditions that depend on results of actions of the plurality of agents. Furthermore, by learning the policy of the own agent in order, the policy update unit 26 grasps the actions of only the own agent, and thus makes it possible to avoid an exponential increase in the dimensions of the action space. Then, the policy update unit 26 causes the degree of influence after the update to be shared with the next agent in the update order.

Furthermore, when determining that the update width of the policy parameter of the own agent is not within the range determined depending on the degree of influence on the constraint conditions specific to the own agent and the range determined depending on the degree of influence on the system-wide constraint conditions, the policy update unit 26 performs the following processing. For example, the policy update unit 26 does not update of the policy parameters of the own agent and the subsequent agents in the update order. This is because of absence of an update width by which the policy parameter is updatable. For example, this is because the range of the policy parameter satisfying the agent-specific constraint conditions and the range of the policy parameter satisfying the system-wide constraint conditions do not have a common portion of the update width. As a result, the policy update unit 26 may guarantee that the constraint conditions specific to each agent and also the system-wide constraint conditions that depend on results of actions of the plurality of agents will be satisfied during and after the learning.

The learning update unit 27 updates data to be used for the learning. For example, the learning update unit 27 updates the learning parameters to be used in the reinforcement learning. The learning parameters mentioned herein refer to learning parameters other than the policy parameter. Furthermore, the learning update unit 27 increments a count for learning episodes to be used in the reinforcement learning. Then, when the learning episode count is smaller than a maximum learning episode count, the learning update unit 27 performs learning in the next learning episode. Then, in a case where the learning episode count becomes the maximum learning episode count, the learning update unit 27 ends the learning. For example, a learned policy of each agent is generated.

The prediction unit 30 includes a selection unit 31 and an action prediction unit 32.

The selection unit 31 selects a true value or an alternative value to be acquired as a value of a state to be input to its own policy according to the priority information 41 for an agent to be predicted. For example, the selection unit 31 acquires the priority pᵢₛⱼ of the state sⱼ (j=1, . . . , N) corresponding to its own agent i from the priority information 41. Then, the selection unit 31 compares the priority pᵢₛⱼ with a predetermined threshold, and when the priority pᵢₛⱼ is equal to or larger than the threshold, acquires the true value of the state sⱼ from an agent j. Furthermore, when the priority pᵢₛⱼ is less than the threshold, the selection unit 31 changes the state sⱼ to an alternative value. The selection unit 31 generates the state sⱼ (j=1, . . . , N) corresponding to its own agent i.

The action prediction unit 32 predicts an action of the agent to be predicted using the learned policy. For example, the action prediction unit 32 inputs the state sⱼ (j=1, . . . , N) to the learned policy for the agent i to be predicted, and predicts an action of the agent i to be predicted using the learned policy parameter.

[Images of Multi-Agent Reinforcement Learning Processing]

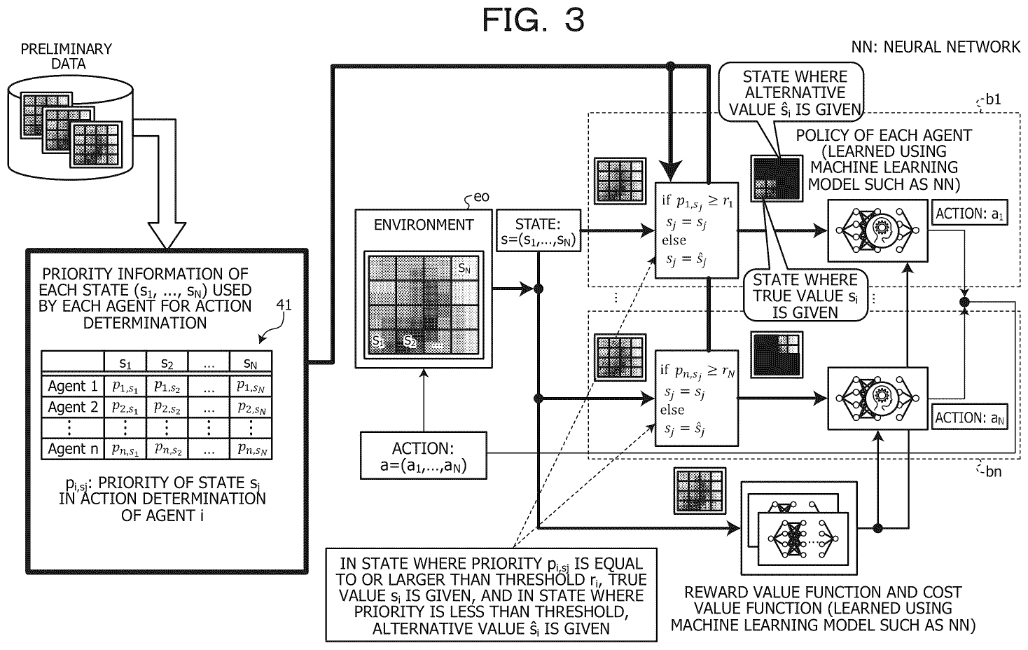

Here, images of the multi-agent reinforcement learning processing according to the embodiment will be described with reference to FIG. 3. FIG. 3 is a diagram illustrating the images of the multi-agent reinforcement learning processing according to the embodiment.

As illustrated in FIG. 3, the priority determination unit 21 determines the priority pᵢₛⱼ of each state (s₁, . . . , s_{N}) used by each agent i for action determination from preliminary data. The priority pᵢₛⱼ is the priority of the state sⱼ (j=1, . . . , N) in the action determination of the agent i. For example, the priority determination unit 21 specifies a relationship between agents by using the preliminary data. Then, the priority determination unit 21 uses the relationship between the agents to determine priority of the respective states to be used when actions of the agents are determined. For example, the priority determination unit 21 determines the priority of each state (s₁, . . . , s_{N}) used at the time of action determination for each agent. Then, the priority determination unit 21 stores the priority of each state (s₁, . . . , s_{N}) in the priority information 41 in association with the agent.

Furthermore, it is assumed that the combination history information 42 regarding a combination of states, an action, and a reward, which is a result of execution of control for a certain time period, is saved. The policy update unit 26 inputs the combination of the states, the action, and the reward for the certain time period saved in the combination history information 42, and updates the policy of each agent. Here, it is assumed that an environment e0 at a certain time point is input. The environment e0 at the certain time point refers to N states s at the certain time point. The states s are (s₁, . . . , s_{N}). Then, the actions a are input at the same time point. The actions a are the respective actions (a₁, . . . , aₙ) corresponding to n agents. Then, the rewards are input at the same time point.

In such a case, the selection unit 24 performs the following according to the update order of the agent. The selection unit 24 acquires the priority pᵢₛⱼ (j=1, . . . , N) of the state sⱼ corresponding to its own agent i from the priority information 41. Then, the selection unit 24 compares the priority pᵢₛⱼ with a predetermined threshold rᵢ, and when the priority pᵢₛⱼ is equal to or larger than the threshold rᵢ, acquires a true value of the state sⱼ from the combination history information 42, and when the priority pᵢₛⱼ is less than the threshold rᵢ, changes the state sⱼ to an alternative value. The selection unit 24 generates the state sⱼ (j=1, . . . , N) corresponding to its own agent i. Note that it is assumed that n is the threshold corresponding to the agent i.

A reference sign b1 indicates a case where the state sⱼ (j=1, . . . , N) corresponding to the agent 1 is selected. The selection unit 24 acquires the priority pᵢₛⱼ of the state sⱼ corresponding to its own agent 1 from the priority information 41. Then, the selection unit 24 compares the priority pᵢₛⱼ with a predetermined threshold r₁, and when the priority pᵢₛⱼ is equal to or larger than the threshold rᵢ, acquires a true value of the state sⱼ from the combination history information 42, and when the priority pᵢₛⱼ is less than the threshold r₁, changes the state sⱼ to an alternative value. The selection unit 24 generates the state sⱼ (j=1, . . . , N) corresponding to its own agent 1. In the generated states s, the state changed to the alternative value is changed to black.

Then, the calculation unit 25 calculates the degree of influence on the constraint conditions specific to the agent 1 and the degree of influence on the system-wide constraint conditions associated with the policy update of the preceding agent in the update order. Then, the policy update unit 26 updates a policy parameter of the agent 1 in a case where an update width of the policy parameter of the agent 1 is within a range determined depending on the degree of influence on the constraint conditions specific to the agent 1 and the degree of influence on the system-wide constraint conditions. On the other hand, the policy update unit 26 does not update the policy parameters of the agent 1 and the subsequent agents in the update order in a case where the update width of the policy parameter of the agent 1 is not within the range determined depending on the degree of influence on the constraint conditions specific to the agent 1 and the degree of influence on the system-wide constraint conditions. Then, in a case where the policy parameter of the agent 1 is updated, the policy update unit 26 causes the degree of influence after the update to be shared with the next agent in the update order.

Furthermore, a reference sign bn indicates a case where the state sⱼ (j=1, . . . , N) corresponding to an agent n is selected according to the update order. Also in the case of the agent n, selection is performed similarly to the case of the agent 1. In the generated states s, the state changed to the alternative value is changed to black.

Then, also in the case of the agent n, similarly to the case of the agent 1, the calculation unit 25 calculates the degree of influence on the constraint conditions specific to the agent n and the degree of influence on the system-wide constraint conditions associated with the policy update of the preceding agent in the update order. Then, the policy update unit 26 updates a policy parameter of the agent n in a case where an update width of the policy parameter of the agent n is within a range determined depending on the degree of influence on the constraint conditions specific to the agent n and the degree of influence on the system-wide constraint conditions. On the other hand, the policy update unit 26 does not update the policy parameters of the agent n and the subsequent agents in the update order in a case where the update width of the policy parameter of the agent n is not within the range determined depending on the degree of influence on the constraint conditions specific to the agent n and the degree of influence on the system-wide constraint conditions. In this manner, in the multi-agent reinforcement learning processing, a policy of each agent is learned.

As a result, in the multi-agent reinforcement learning processing according to the embodiment, even when the number of states to which true values are given is reduced for each agent at the time of learning, it is possible to appropriately learn a policy of each agent. Furthermore, even at the time of prediction after the learning, it is possible to appropriately determine (predict) an action using the learned policy even when the number of states to which true values are given is reduced for an agent to be predicted. In addition, at the time of prediction after the learning, it is possible to suppress a cost of exchanging information regarding the true value of the state with another agent for the agent to be predicted.

### [Flowchart of Multi-Agent Reinforcement Learning Processing]

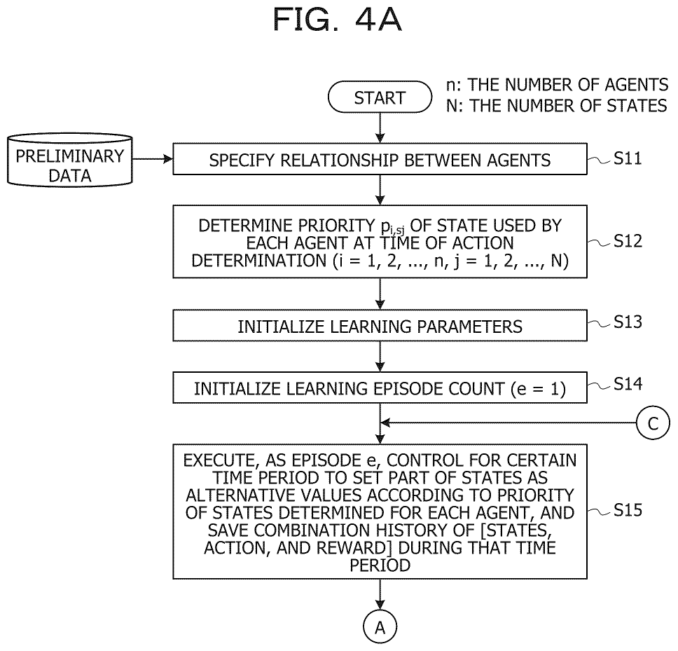

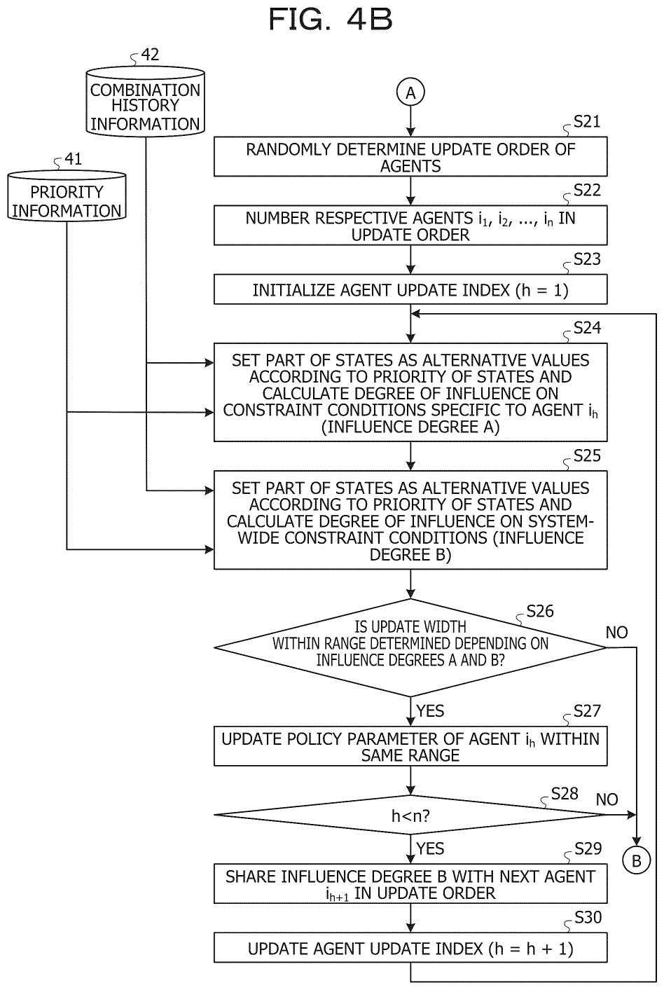

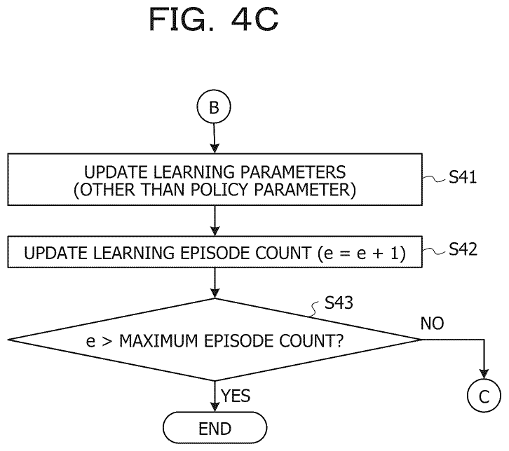

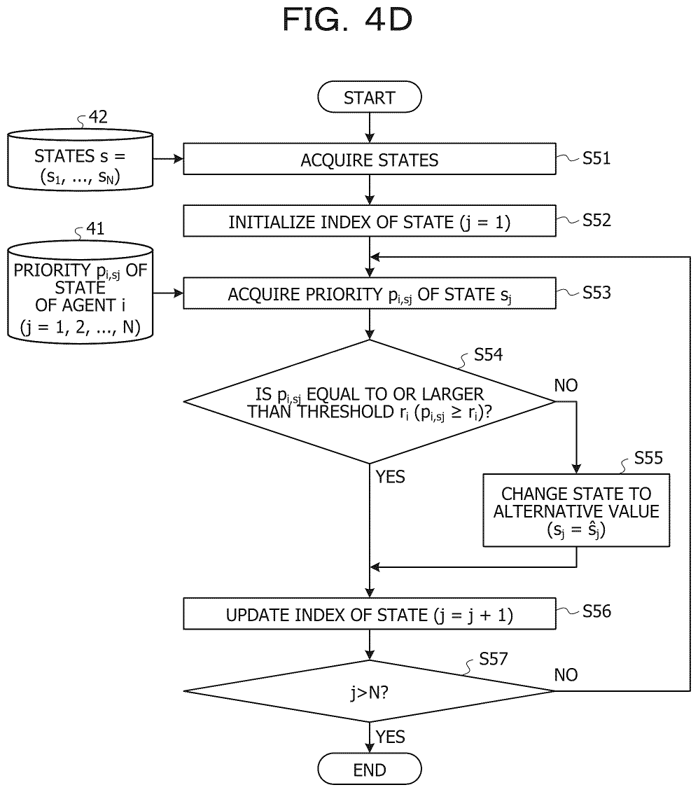

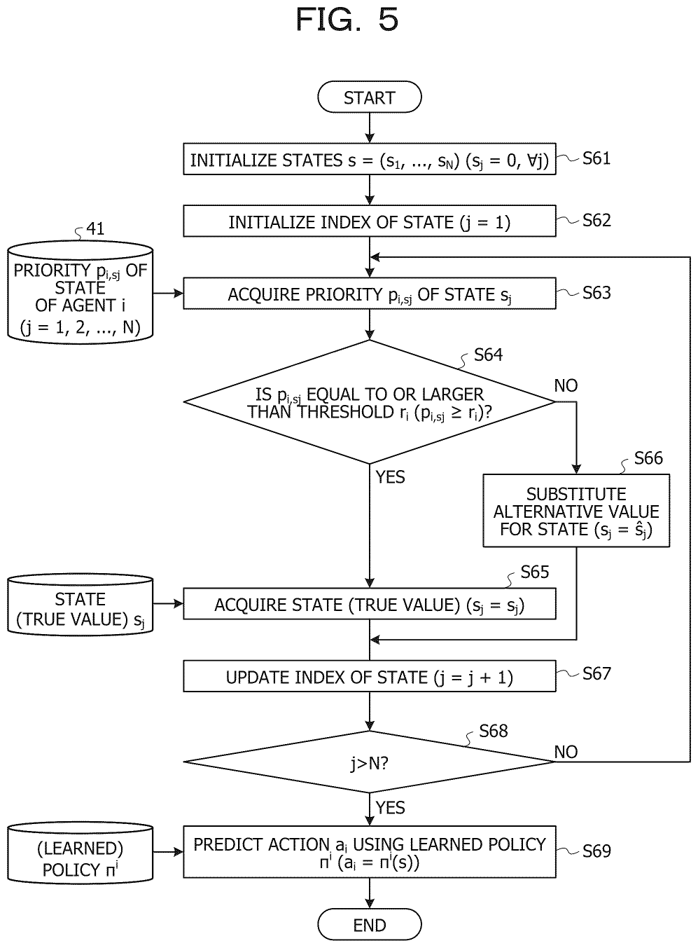

Next, an example of an overall flowchart of the multi-agent reinforcement learning processing according to the embodiment will be described. FIGS. 4A to 4D are diagrams illustrating an example of an overall flowchart of learning processing according to the embodiment. FIG. 5 is a diagram illustrating an example of an overall flowchart of prediction processing according to the embodiment.

### [Flowchart of Learning Processing]

As illustrated in FIG. 4A, the information processing device 1 specifies a relationship between agents from preliminary data (step S11). Then, the information processing device 1 determines the priority pᵢₛⱼ of a state used by each agent at the time of action determination based on the specified relationship between the agents (step S12). Here, i is an index for identifying an agent, and indicates 1, 2, . . . , n. Here, j is an index for identifying a state, and indicates 1, 2, . . . , N.

Then, the information processing device 1 initializes the learning parameters (step S13). The information processing device 1 initializes the learning episode count e to “1” (step S14). As the episode e, the information processing device 1 executes control for a certain time period to set a part of the states as alternative values according to priority of states determined for each agent, and saves a combination history of [states, an action, and a reward] during that time period in the combination history information 42 (step S15). Note that a flowchart of the processing of setting a part of the states as the alternative values according to the priority of the states will be described later. Then, the information processing device 1 proceeds to step S21.

As illustrated in FIG. 4B, the information processing device 1 randomly determines an update order of the agents (step S21). The information processing device 1 numbers the respective agents i₁, i₂, . . . , iₙ in the update order, for example (step S22). Here, it is assumed that n is the number of agents. The information processing device 1 initializes the agent update index h (step S23). Here, the information processing device 1 sets “1” in the variable h.

By using the priority information 41 and the combination history information 42, the information processing device 1 sets a part of the states as the alternative values according to the priority of the states and calculates a degree of influence on constraint conditions specific to an agent iₕ (influence degree A) (step S24). Note that a flowchart of the processing of setting a part of the states as the alternative values according to the priority of the states will be described later.

Furthermore, by using the priority information 41 and the combination history information 42, the information processing device 1 sets a part of the states as the alternative values according to the priority of the states and calculates a degree of influence on the system-wide constraint conditions (influence degree B) (step S25). Note that a flowchart of the processing of setting a part of the states as the alternative values according to the priority of the states will be described later.

The information processing device 1 determines whether or not an update width of a policy parameter of the agent iₕ is within a range determined depending on the influence degree A and the influence degree B (step S26). When determining that the update width of the policy parameter of the agent iₕ is not within the range determined depending on the influence degree A and the influence degree B (step S26; No), the information processing device 1 performs the following processing. For example, the information processing device 1 proceeds to step S41 without updating the policy parameter of the agent iₕ and the policy parameters of the subsequent agents.

On the other hand, when determining that the update width of the policy parameter of the agent iₕ is within the range determined depending on the influence degree A and the influence degree B (step S26; Yes), the information processing device 1 performs the following processing. For example, the information processing device 1 updates the policy parameter of the agent iₕ within the range determined depending on the influence degree A and the influence degree B (step S27).

Then, the information processing device 1 determines whether or not the agent update index h is smaller than the number n of the agents (step S28). When determining that h is equal to or larger than n (step S28; No), the information processing device 1 proceeds to step S41 since the processing corresponding to the number of agents is ended.

When determining that h is smaller than n (step S28; Yes), the information processing device 1 causes the influence degree B to be shared with the next agent iₕ₊₁ in the update order (step S29). Then, the information processing device 1 updates the agent update index h by 1 (step S30). Then, the information processing device 1 proceeds to step S24 to execute the update processing on the next agent iₕ₊₁ in the update order.

As illustrated in FIG. 4C, in step S41, the information processing device 1 updates the learning parameters other than the policy parameter (step S41). The information processing device 1 updates the learning episode count by 1 (step S42).

Then, the information processing device 1 determines whether or not the learning episode count e is larger than a maximum episode count (step S43). When determining that the learning episode count e is not larger than the maximum episode count (step S43; No), the information processing device 1 proceeds to step S15 to perform processing on the next learning episode.

On the other hand, when determining that the learning episode count e is larger than the maximum episode count (step S43; Yes), the information processing device 1 ends the multi-agent reinforcement learning processing.

Here, an example of the flowchart of the processing of setting a part of the states as the alternative values according to the priority of the states will be described with reference to FIG. 4D. As illustrated in FIG. 4D, the information processing device 1 acquires the states s of the agent i from the combination history information 42 (step S51). It is assumed that the states s are (s₁, . . . , s_{N}). The information processing device 1 initializes an index j of the state to “1” (step S52).

Then, the information processing device 1 acquires the priority pᵢₛⱼ of the state sⱼ of the agent i from the priority information 41 (step S53). Then, the information processing device 1 determines whether or not the priority pᵢₛⱼ is equal to or larger than the threshold rᵢ (step S54). Here, rᵢ is the threshold corresponding to the agent i. When determining that the priority pᵢₛⱼ is less than the threshold rᵢ (step S54; No), the information processing device 1 changes the state sⱼ of the agent i to an alternative value (step S55). Then, the information processing device 1 proceeds to step S56.

On the other hand, when determining that the priority pᵢₛⱼ is equal to or larger than the threshold rᵢ (step S54; Yes), the information processing device 1 sets a true value of the acquired state sⱼ as a value of the state sⱼ. Then, the information processing device 1 proceeds to step S56.

In step S56, the information processing device 1 updates the index of the state by 1 (step S56). Then, the information processing device 1 determines whether or not the index j of the state is larger than N, which is a maximum value of the index for identifying the state (step S57). When determining that the index j of the state is equal to or smaller than N (step S57; No), the information processing device 1 proceeds to step S53 to perform processing on a value of the next state.

On the other hand, when determining that the index j of the state is larger than N (step S57; Yes), the information processing device 1 ends the processing of setting a part of the states as the alternative values according to the priority of the states for the agent i.

### [Flowchart of Prediction Processing]

As illustrated in FIG. 5, the information processing device 1 initializes all elements of the states s (step S61). The states s mentioned herein are (s₁, . . . , s_{N}). The information processing device 1 initializes each element of the states s to “0”. Then, the information processing device 1 initializes the index j of the state to “1” (step S62).

Then, the information processing device 1 acquires the priority pᵢₛⱼ of the state sⱼ of the agent i from the priority information 41 (step S63). Then, the information processing device 1 determines whether or not the priority pᵢₛⱼ is equal to or larger than the threshold rᵢ (step S64). Here, n is the threshold corresponding to the agent i. When determining that the priority pᵢₛⱼ is equal to or larger than the threshold rᵢ (step S64; Yes), the information processing device 1 acquires a true value of the state sⱼ (step S65). For example, the information processing device 1 acquires the true value of the state sⱼ from an agent corresponding to the state sⱼ. Then, the information processing device 1 proceeds to step S67.

On the other hand, when determining that the priority pᵢₛⱼ is less than the threshold rᵢ (step S64; No), the information processing device 1 substitutes an alternative value for the state sⱼ of the agent i (step S66). Then, the information processing device 1 proceeds to step S67.

In step S67, the information processing device 1 updates the index j of the state by 1 (step S67). Then, the information processing device 1 determines whether or not the index j of the state is larger than N, which is the maximum value of the index for identifying the state (step S68). When determining that the index j of the state is equal to or smaller than N (step S68; No), the information processing device 1 proceeds to step S63 to perform processing on a value of the next state.

On the other hand, when determining that the index j of the state is larger than N (step S68; Yes), the information processing device 1 determines (predicts) an action aᵢ using a learned policy nⁱ of the agent i (step S69). Then, the information processing device 1 ends the prediction processing of the agent i.

Note that, in FIGS. 4A to 4D, when the episode e is updated, the information processing device 1 executes control for a certain time period, and saves a combination history of states, an action, and a reward for each agent during that time period in the combination history information 42. Then, it has been described that the information processing device 1 uses this combination history information 42 to update the policy of each agent in the updated episode e. However, the information processing device 1 is not limited to this, and when the episode e is updated, the information processing device may update the policy of each agent in the updated episode e by using the combination history already saved in the combination history information 42.

### [Application Example of Multi-Agent Reinforcement Learning]

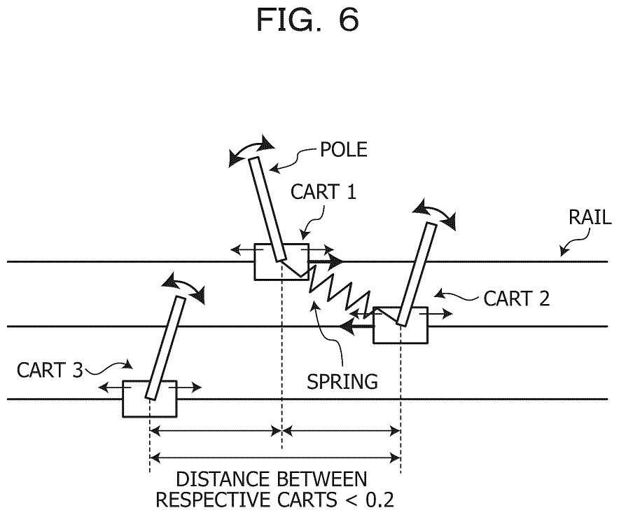

Here, an application example of the multi-agent reinforcement learning according to the embodiment will be described with reference to FIGS. 6, 7A, 7B, 8, 9A, and 9B. First, an example in which the multi-agent reinforcement learning according to the embodiment is applied will be described with reference to FIG. 6. FIG. 6 is a diagram illustrating an example in which the multi-agent reinforcement learning according to the embodiment is applied. In FIG. 6, an experimental result in a case where an algorithm for controlling three cart poles (moving on three parallel rails) is learned will be described.

As illustrated in FIG. 6, the three cart poles are mounted on the respective three parallel rails. A cart 1 and a cart 2 are coupled by a spring, and there is interference in mutual state transition. Each cart pole is an example of the “agent”. To set a cost to “1” in a case where a distance between all the carts is larger than 0.2, to set the cost to “0” otherwise, and to keep a cumulative discounted cost (hereinafter, referred to as “discounted cost”) at equal to or smaller than 25 for each episode are examples of the system-wide “constraint conditions”. Positions and speeds of the three carts and angles and angular velocities of the poles thereof are examples of the “states”. The state in such a case is 12 (=three carts×four types) dimensions in total. To move each of the carts to the right or left (give an input of 0 or 1 to each cart) is an example of the “action”. A time period during which all of the poles of the three carts do not fall from an initial state is an example of the “reward (objective function)”. The maximum of that time period is 200 steps (seconds), and the initial state is randomly set within a certain range. Note that, for simplification of the problem, the experiment was made by only considering the system-wide constraint conditions (without considering the agent-specific constraint conditions).

Under such experimental conditions, the multi-agent reinforcement learning was tried.

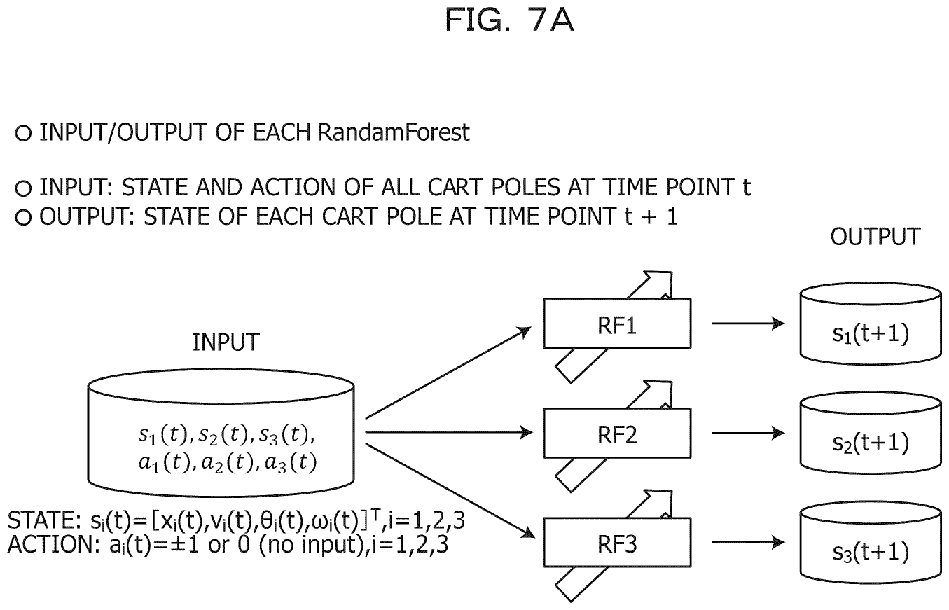

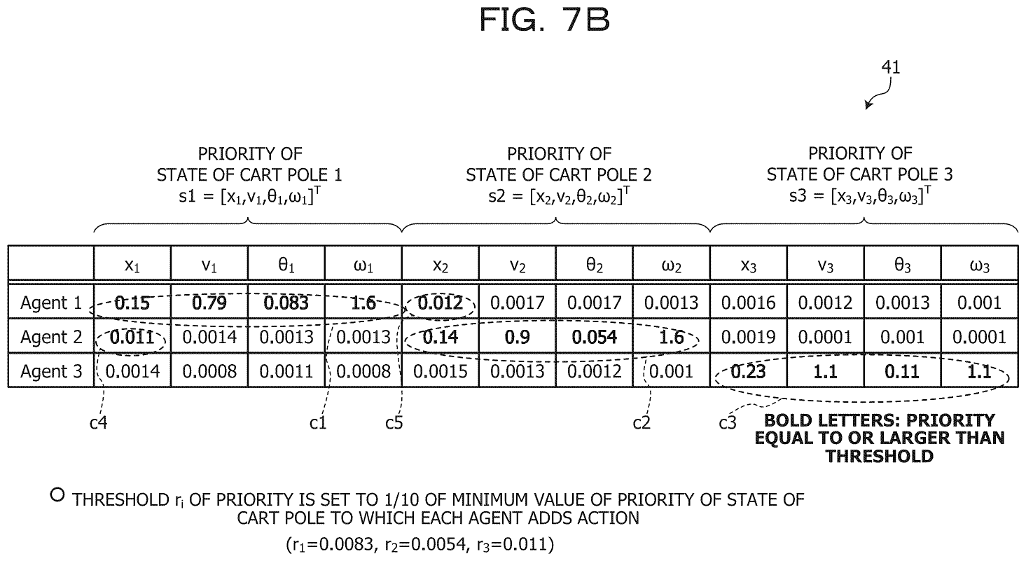

FIGS. 7A and 7B are diagrams illustrating an example of priority determination according to the embodiment.

As illustrated in FIG. 7A, the information processing device 1 learns Random Forests (RF1 to RF3), which are examples of the decision tree algorithm, by using input/output information collected in advance. The input information in the input/output information mentioned herein indicates the state sᵢ and the action aᵢ (i=1, 2, 3) of all the cart poles at the time point t. Here, i is an index for identifying an agent. The state sᵢ(t) includes a position xᵢ(t) and a speed vᵢ(t) of a cart of the agent i at the time point t and an angle θᵢ(t) and an angular velocity ωᵢ(t) of the pole thereof. The action aᵢ(t) is an action of the agent i, and indicates ±1 or 0 (no input). Additionally, the output information in the input/output information mentioned herein indicates the state sᵢ (i=1, 2, 3) of each cart pole at the time point t+1.

As illustrated in FIG. 7B, the information processing device 1 determines priority (permutation importance) of a state used for action determination of each agent by using the learned Random Forests. Then, the information processing device 1 stores the priority of each state in the priority information 41 in association with the agent. Here, an agent 1 corresponds to the cart pole 1. An agent 2 corresponds to the cart pole 2. An agent 3 corresponds to the cart pole 3. A state of the cart pole 1 to which the agent 1 adds an action corresponds to s₁, and s₁ is [x₁, v₁, θ₁, ω₁]^{T}. A state of the cart pole 2 to which the agent 2 adds an action corresponds to s₂, and s₂ is [x₂, v₂, θ₂, ω₂]^{T}. A state of the cart pole 3 to which the agent 3 adds an action corresponds to s₃, and s₃ is [x₃, v₃, θ₃, ω₃] T.

For example, priority of the state s₁ (=[x₁, v₁, θ₁, ω₁]^{T}) of the cart pole 1 corresponding to the agent 1 is determined as [0.15, 0.79, 0.083, 1.6]. Priority of the state s₁ (=[x₁, v₁, θ₁, ω₁]^{T}) of the cart pole 1 corresponding to the agent 2 is determined as [0.011, 0.0014, 0.0013, 0.0013]. Priority of the state s₁ (=[x₁, v₁, θ₁, ω₁]^{T}) of the cart pole 1 corresponding to the agent 3 is determined as [0.0014, 0.0008, 0.0011, 0.0008].

Then, the threshold n of the priority is set to, for example, 1/10 of a minimum value of the priority of the state of the cart pole to which each agent adds an action. A threshold r₁ of the priority of the agent 1 is “0.0083” indicating 1/10 of a minimum value “0.083” in the priority [0.15, 0.79, 0.083, 1.6] (reference sign c1) of the state of the cart pole 1 to which the agent 1 adds an action. A threshold r₂ of the priority of the agent 2 is “0.0054” indicating 1/10 of a minimum value “0.054” in the priority [0.14, 0.9, 0.054, 1.6] (reference sign c2) of the state of the cart pole 2 to which the agent 2 adds an action. A threshold r₃ of the priority of the agent 3 is “0.011” indicating 1/10 of a minimum value “0.11” in the priority [0.23, 1.1, 0.11, 1.1] (reference sign c3) of the state of the cart pole 3 to which the agent 3 adds an action.

Additionally, bold letters in the priority information 41 indicate the priority equal to or larger than the threshold. Since the state [x₁, v₁, θ₁, ω₁]^{T} of the cart pole 1 corresponding to the agent 1 is the state (reference sign c1) of the cart pole 1 to which the agent 1 adds an action, the priority thereof is equal to or larger than the threshold r₁. Furthermore, since the state x₁ in the state [x₁, v₁, θ₁, ω₁]^{T} of the cart pole 1 corresponding to the agent 2 is interfered by coupling the cart pole 2 and the spring, the priority thereof is equal to or larger than the threshold r₁ (reference sign c4). Since the state [x₂, v₂, θ₂, ω₂]^{T} of the cart pole 2 corresponding to the agent 2 is the state (reference sign c2) of the cart pole 2 to which the agent 2 adds an action, the priority thereof is equal to or larger than the threshold r₂. Furthermore, since the state x₂ in the state [x₂, v₂, θ₂, ω₂]^{T} of the cart pole 2 corresponding to the agent 1 is interfered by coupling the cart pole 1 and the spring, the priority thereof is equal to or larger than the threshold r₂ (reference sign c5). Furthermore, since the state [x₃, v₃, θ₃, ω₃]^{T} of the cart pole 3 corresponding to the agent 3 is the state (reference sign c3) of the cart pole 3 to which the agent 3 adds an action, the priority thereof is equal to or larger than the threshold r₃.

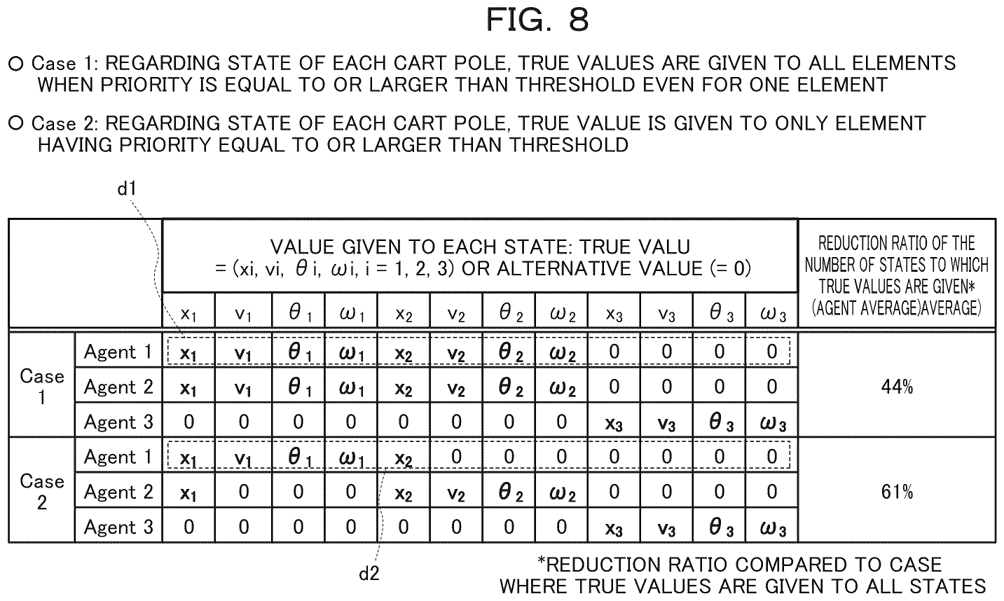

FIG. 8 is a diagram illustrating an example of a method of setting a part of the states as the alternative values according to the priority of the states. In FIG. 8, the control of the three cart poles is learned by giving a true value or an alternative value (for example, “0”) to each state under conditions of Case 1 and Case 2 according to the priority of the states of the priority information 41 illustrated in FIG. 7B. In Case 1, regarding the state of each cart pole, true values are given to all elements when the priority is equal to or larger than the threshold even for one element. In Case 2, regarding the state of each cart pole, a true value is given to only an element having the priority equal to or larger than the threshold.

The information processing device 1 acquires the priority pᵢₛⱼ of the state sⱼ corresponding to its own agent i from the priority information 41. Then, the information processing device 1 compares the priority pᵢₛⱼ with the predetermined threshold rᵢ, and when the priority pᵢₛⱼ is equal to or larger than the threshold rᵢ, acquires a true value of the state sⱼ, and when the priority pᵢₛⱼ is less than the threshold rᵢ, changes the state sⱼ to an alternative value.

Here, the information processing device 1 acquires the priority pᵢₛⱼ of the state sⱼ corresponding to the agent 1 from a first row of the priority information 41 illustrated in FIG. 7B. Then, in the state s₁ of the cart pole 1, all the elements are equal to or larger than the threshold r₁, and in the state s₂ of the cart pole 2, an element of x₂ is equal to or larger than the threshold r₁. Thus, in the case of Case 1, (x₁, v₁, θ₁, ω₁) that is a true value is given to all the elements of the state s₁ of the cart pole 1, (x₂, v₂, θ₂, ω₂) that is a true value is given to all the elements of the state s₂ of the cart pole 2, and (0, 0, 0, 0) that is an alternative value is given to all the elements of the state s₃ of the cart pole 3 (reference sign d1). On the other hand, in the case of Case 2, (x₁, v₁, θ₁, ω₁) that is a true value is given to all the elements of the state s₁ of the cart pole 1, but in the state s₂ of the cart pole 2, a true value is given only to x₂, and “0” that is an alternative value is given to other elements. Then, (0, 0, 0, 0) that is an alternative value is given to all the elements of the state s₃ of the cart pole 3 (reference sign d2).

Next, the information processing device 1 acquires priority p₂ₛⱼ of the state sⱼ corresponding to the agent 2 from a second row of the priority information 41 illustrated in FIG. 7B, and sets a part of the states as alternative values according to the priority of the states similarly to the case of the agent 1. Furthermore, the information processing device 1 acquires priority p₃ₛⱼ of the state sⱼ corresponding to the agent 3 from a third row of the priority information 41 illustrated in FIG. 7B, and sets a part of the states as alternative values according to the priority of the states similarly to the cases of the agents 1 and 2.

As a result, in a case where a true value or an alternative value (for example, “0”) is given to each state under the condition of Case 1, the information processing device 1 may reduce the number of states to which the true values are given by 44% as compared with the case of giving the true values to all the states. Furthermore, in a case where a true value or an alternative value (for example, “0”) is given to each state under the condition of Case 2, the information processing device 1 may reduce the number of states to which the true values are given by 61% as compared with the case of giving the true values to all the states. For example, the information processing device 1 may reduce an amount of data for exchanging information between agents at the time of prediction after learning.

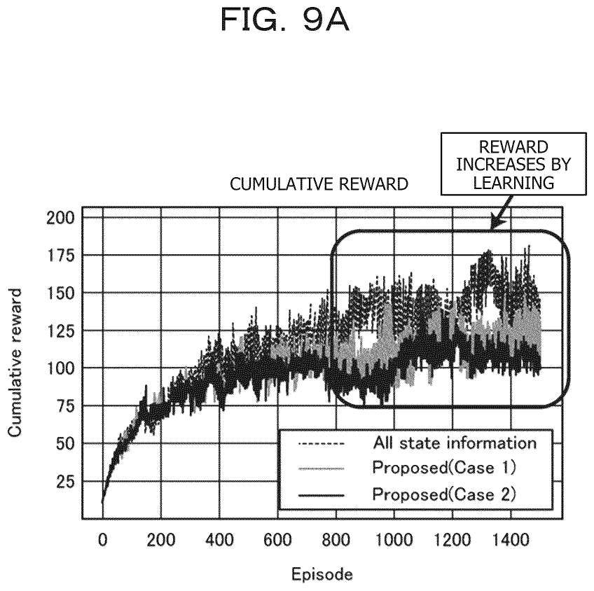

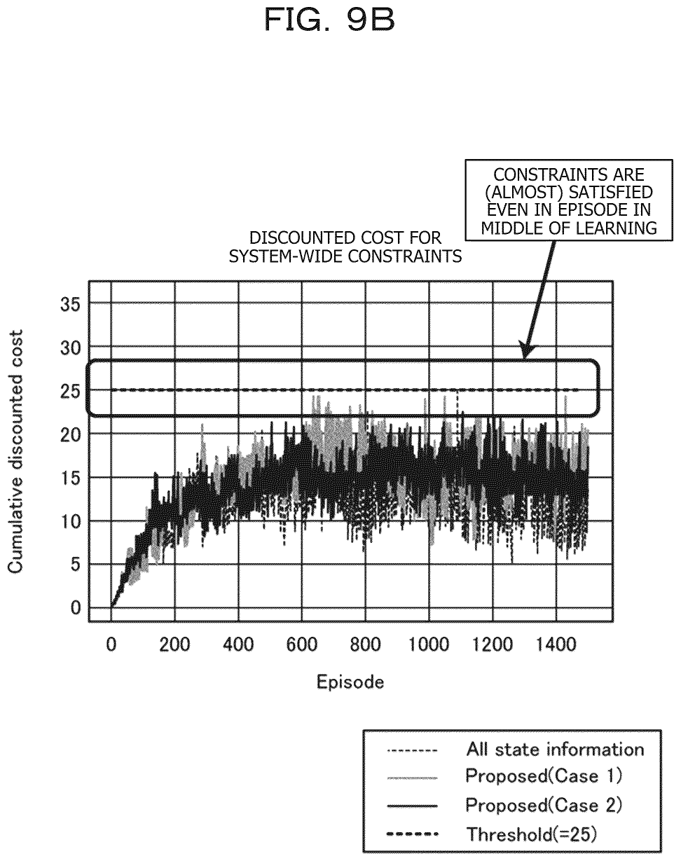

FIGS. 9A and 9B are diagrams illustrating an example of an application result of the multi-agent reinforcement learning according to the embodiment. FIG. 9A represents a graph illustrating a cumulative reward for each episode (cumulative reward) in a case where a true value or an alternative value is given to each state under the conditions of Cases 1 and 2 and in a case where true values are given to all the states. An X-axis of the graph indicates a count for the episodes. A Y-axis of the graph indicates the cumulative reward. A graph illustrated in gray is a result of learning (Proposed Case 1) in which a true value or an alternative value is given to each state under the condition of Case 1. A graph illustrated in black is a result of learning (Proposed Case 2) in which a true value or an alternative value is given to each state under the condition of Case 2. Additionally, a graph indicated by a dot is a result of learning in which true values are given to all the states. Each polygonal line is an average value of five trials.

As illustrated in FIG. 9A, it may be seen that the cumulative reward increases by learning in both the case of learning in which a true value or an alternative value is given to each state under the conditions of Cases 1 and 2 and the case of learning in which true values are given to all the states. For example, it may be seen that the reward increases due to learning even when the number of states to which true values are given is reduced.

Furthermore, FIG. 9B represents a graph illustrating a discounted cost for the system-wide constraints for each episode in a case where a true value or an alternative value is given to each state under the conditions of Cases 1 and 2 and in a case where true values are given to all the states. An X-axis of the graph indicates a count for the episodes. A Y-axis of the graph indicates the discounted cost. A dashed line is a threshold, indicating “25” as the discounted cost for the system-wide constraints. The threshold is “25” because the system-wide constraint conditions include keeping the discounted cost in each episode equal to or smaller than 25. A graph illustrated in gray is a result of learning (Proposed Case 1) in which a true value or an alternative value is given to each state under the condition of Case 1. The graph illustrated in black is a result of learning (Proposed Case 2) in which a true value or an alternative value is given to each state under the condition of Case 2. Additionally, a graph indicated by a dot is a result of learning in which true values are given to all the states. Each polygonal line is an average value of five trials.

As illustrated in FIG. 9B, a result in which the discounted cost for the system-wide constraints hardly exceeds the threshold “25” in both the case of learning in which a true value or an alternative value is given to each state under the conditions of Cases 1 and 2 and the case of learning in which true values are given to all the states is represented. For example, it may be seen that, even when the number of states to which true values are given is reduced, the system-wide constraints are almost satisfied even in an episode in the middle of learning.

Therefore, in the multi-agent reinforcement learning according to the embodiment, even when the number of states to which true values are given is reduced at the time of learning, it is possible to learn an appropriate policy for increasing a reward while satisfying the system-wide constraint conditions. In addition, at the time of prediction after the learning, by reducing the number of states to which true values are given, it is possible to suppress a cost of exchanging information regarding the true value of the state with another agent for the agent to be predicted.

Note that, in FIGS. 6, 7A, 7B, 8, 9A, and 9B, the case of learning the algorithm of the control of the three cart poles has been described as an application example of the multi-agent reinforcement learning according to the embodiment. However, the multi-agent reinforcement learning according to the embodiment is not limited to this.

For example, the multi-agent reinforcement learning according to the embodiment may be applied to a case of learning an algorithm of wave transmission stop control in a base station (BS) of a communication network. In such a case, while an average satisfaction level of all users attached to the BSs of the respective areas are kept at a certain or higher level, the algorithm of the wave transmission stop control of each BS that minimizes a total sum of power consumption of all the BSs is learned. Here, each BS is an example of the agent. Keeping a certain or higher average satisfaction level of all the users is an example of the “constraint conditions” including the entire system. A time point, an amount of grid demand, a load of a BS at a previous time point, power consumption of the BS at the previous time point, and the like are examples of the “states”. Whether or not to stop wave transmission of the BS (turning the BS on/off) is an example of the “actions”. The total sum of power consumption of all the BSs is an example of the “reward (objective function)”.

As a result, in the multi-agent reinforcement learning, an amount of data to be collected at the time of prediction after learning may be reduced by learning and predicting a state with low priority by giving an alternative value. The state with low priority refers to, for example, a state of an area in a far distance from an area controlled by each agent. Furthermore, it is possible to perform cooperative BS wave transmission stop control over a wide range across a plurality of areas, and power saving performance is further improved. Furthermore, the multi-agent reinforcement learning may implement guarantee of the user satisfaction level of the entire area without tuning a weighting coefficient or a penalty term of an objective function, and may reduce man-hours needed for trial and error of the learning.

Furthermore, in another example, the multi-agent reinforcement learning may be applied to a case of learning an algorithm of air conditioning control in a data center. In such a case, an algorithm for controlling each air conditioner is learned so as to minimize a total sum of power consumption of all of a plurality of air conditioners installed in the data center while keeping a temperature of a server in the data center at equal to or smaller than a certain value. Here, keeping the temperature of the server in the data center at equal to or smaller than the certain value is an example of the “constraint condition” including the entire system. A time point, the temperature of the server, power consumption of the server at a previous time point, a set temperature of the air conditioner at the previous time point, and the like are examples of the “states”. A set temperature (or a command to raise or lower the set temperature) of each air conditioner, strength of air conditioning, and the like are examples of the “actions”. The total sum of the power consumption of all the air conditioners is an example of the “reward (objective function)”.

As a result, in the multi-agent reinforcement learning, an amount of data to be collected at the time of prediction after learning may be reduced by learning and predicting a state with low priority by giving an alternative value. The state with low priority refers to, for example, a state of a server away from the air conditioner controlled by each agent. Furthermore, it is possible to perform cooperative air conditioning control of the plurality of air conditioners, and power saving performance is further improved. Furthermore, the multi-agent reinforcement learning may implement guarantee that the temperature of the server in the data center is equal to or smaller than the certain value without tuning a weighting coefficient or a penalty term of an objective function, and may reduce man-hours needed for trial and error of the learning.

### [Effects of Embodiment]

According to the embodiment described above, in a constrained control problem in which a plurality of agents exists, the information processing device 1 determines priority of a state to be used at the time of making an action for a first agent among the plurality of agents based on a relationship among the plurality of agents. Then, for the first agent, the information processing device 1 selects a true value or an alternative value as a value to be input to a first policy parameter according to the priority of the state. Then, the information processing device 1 determines, for the first agent, a first degree of influence on a constraint condition of the first agent and a third degree of influence on system-wide constraint conditions based on a second degree of influence by a second policy parameter updated by a second agent in a previous order in an update order according to a predetermined update order by using the first policy parameter to which the value is input. Then, the information processing device 1 determines a range of a policy parameter that satisfies the constraint condition according to the first degree of influence and the third degree of influence. According to such a configuration, the information processing device 1 may appropriately learn a policy of each agent even when the number of states to which true values are given is reduced. For example, even when the number of states to which true values are given is reduced, the information processing device 1 may appropriately learn the policy of each agent that increases a reward while satisfying the constraints.

Furthermore, according to the embodiment described above, the information processing device 1 determines, for the first agent, the priority of the state to be used at the time of making an action, by using a predetermined decision tree algorithm. According to such a configuration, by using the predetermined decision tree algorithm, the information processing device 1 may specify a relationship between the first agent and another agent, and calculate the priority of the state for the first agent.

Furthermore, according to the embodiment described above, the information processing device 1 determines, for the first agent, the priority of the state to be used at the time of making an action, by using a correlation between the agents. According to such a configuration, by using the correlation between the agents, the information processing device 1 may specify a relationship between the first agent and another agent, and calculate the priority of the state for the first agent.

Furthermore, according to the embodiment described above, the information processing device 1 compares the determined priority of the state with a threshold indicating a condition of a state to which a true value is given for the first agent, and selects a true value or an alternative value as the value to be input. According to such a configuration, the information processing device 1 may select the true value or the alternative value as the value to be input by using the threshold indicating the condition of the state to which the true value is given.

Furthermore, according to the embodiment described above, the information processing device 1 selects a true value or an alternative value acquired from another agent as a value to be input to a state for an agent to be predicted according to the priority of the state. Then, the information processing device 1 inputs the state in which the value is input to a learned policy, and predicts an action of the agent to be predicted using a learned policy parameter. According to such a configuration, at the time of prediction after the learning, the information processing device 1 may suppress a cost of exchanging information regarding the true value of the state with the another agent for the agent to be predicted.

Note that the case where the illustrated information processing device 1 includes the learning unit 20 and the prediction unit 30 has been described. However, there may be a plurality of information processing devices 1, and a first information processing device among the plurality of information processing devices 1 may include the learning unit 20, and a second information processing device among the plurality of information processing devices 1 may include the prediction unit 30. In such a case, it is sufficient that the second information processing device stores a learned policy learned by the first information processing device in the storage unit 40.

Furthermore, each of the illustrated components of the information processing device 1 is not necessarily physically configured as illustrated in the drawings. For example, specific forms of distribution and integration of the information processing device 1 are not limited to the illustrated ones, and all or a part of the information processing device 1 may be configured by being functionally or physically distributed and integrated in optional units according to various loads, use situations, or the like. Furthermore, the storage unit 40 may be coupled through a network as an external device of the information processing device 1.

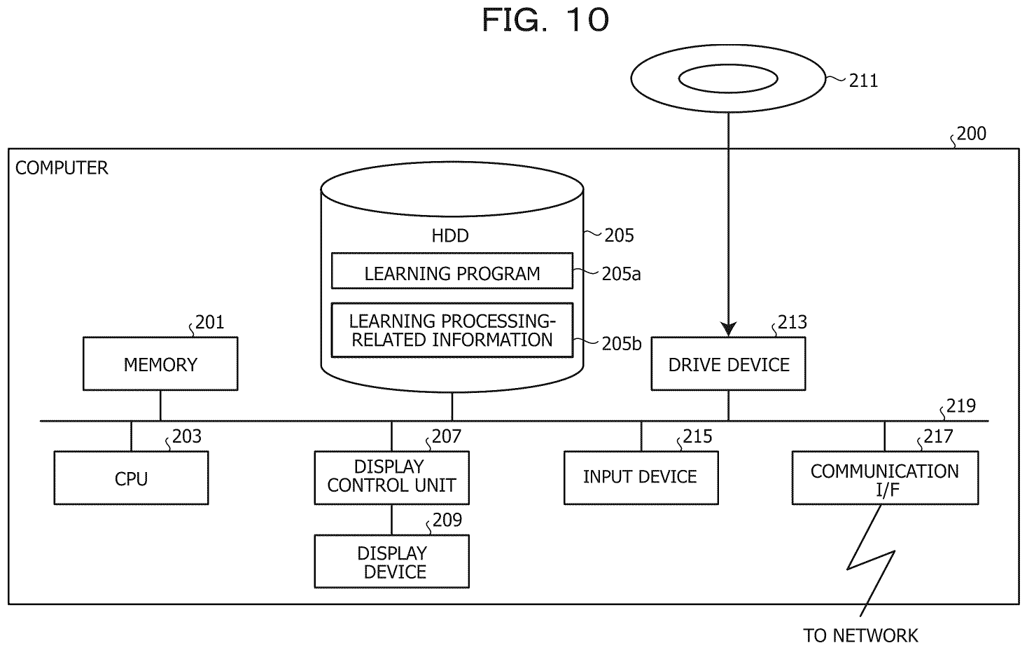

Furthermore, various types of processing described in the embodiment described above may be implemented by a computer such as a personal computer or a workstation executing programs prepared in advance. Thus, in the following, an example of a computer that executes a multi-agent reinforcement learning program that implements functions similar to those of the information processing device 1 illustrated in FIG. 1 will be described. Here, the multi-agent reinforcement learning program that implements the functions similar to those of the information processing device 1 will be described as an example. FIG. 10 is a diagram illustrating an example of the computer that executes the learning program.

As illustrated in FIG. 10, a computer 200 includes a central processing unit (CPU) 203 that executes various types of arithmetic processing, an input device 215 that receives inputs of data from a user, and a display device 209. Furthermore, the computer 200 includes a drive device 213 that reads a program and the like from a storage medium, and a communication interface (I/F) 217 that exchanges data with another computer via a network. Furthermore, the computer 200 includes a memory 201 that temporarily stores various types of information, and a hard disk drive (HDD) 205. Additionally, the memory 201, the CPU 203, the HDD 205, a display control unit 207, the display device 209, the drive device 213, the input device 215, and the communication I/F 217 are coupled by a bus 219.

The drive device 213 is, for example, a device for a removable disk 211. The HDD 205 stores a learning program 205a and learning processing-related information 205b. The communication I/F 217 manages an interface between the network and the inside of the device, and controls input and output of data from another computer. As the communication I/F 217, for example, a modem, a local area network (LAN) adapter, or the like may be adopted.

The display device 209 is a display device that displays data such as a document, an image, or functional information, as well as a cursor, an icon, or a tool box. As the display device 209, for example, a liquid crystal display, an organic electroluminescence (EL) display, or the like may be adopted.

The CPU 203 reads the learning program 205a, loads the read learning program 205a into the memory 201, and executes the loaded learning program 205a as a process. Such a process corresponds to each functional unit of the information processing device 1. The learning processing-related information 205b includes, for example, the priority information 41 and the combination history information 42. Additionally, for example, the removable disk 211 stores each piece of information such as the learning program 205a.

Note that the learning program 205a does not necessarily have to be stored in the HDD 205 from the beginning. For example, the program is stored in a “portable physical medium” such as a flexible disk (FD), a compact disc read only memory (CD-ROM), a digital versatile disc (DVD) disk, a magneto-optical disk, or an integrated circuit (IC) card inserted in the computer 200. Then, the computer 200 may read the learning program 205a from these media and execute the read program.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a learning program for causing a computer to execute processing comprising:
in a constrained control problem in which a plurality of agents exist,
determining priority of a state to be used at a time of making an action for a first agent among the plurality of agents based on a relationship among the plurality of agents;
selecting, for the first agent, a true value or an alternative value as a value to be input to a first policy parameter according to the priority of the state;
determining, for the first agent, a first degree of influence on a constraint condition of the first agent and a third degree of influence on system-wide constraint conditions based on a second degree of influence by a second policy parameter updated by a second agent in a previous order in an update order according to a predetermined update order by using the first policy parameter to which the value is input; and
determining a range of a policy parameter that satisfies the constraint condition according to the first degree of influence and the third degree of influence.

2. The non-transitory computer-readable recording medium according to claim 1, wherein,
in the processing of determining the priority of the state, the priority of the state to be used at the time of making an action is determined for the first agent by using a predetermined decision tree algorithm.

3. The non-transitory computer-readable recording medium according to claim 1, wherein,
in the processing of determining the priority of the state, the priority of the state to be used at the time of making an action is determined for the first agent by using a correlation between the agents.

4. The non-transitory computer-readable recording medium according to claim 1, wherein,
in the processing of selecting a true value or an alternative value, the determined priority of the state is compared with a threshold that indicates a condition of a state to which a true value is given for the first agent, and a true value or an alternative value is selected as the value to be input.

5. The non-transitory computer-readable recording medium according to claim 1, wherein
a true value or an alternative value acquired from another agent is selected as a value to be input to a state for an agent to be predicted according to the priority of the state, and
the state in which the value is input is input to a learned policy, and predicts an action of the agent to be predicted by using a learned policy parameter.

6. An information processing device comprising:
a memory; and
a processor coupled to the memory and configured to:
determine, in a constrained control problem in which a plurality of agents exist, priority of a state to be used at a time of making an action for a first agent among the plurality of agents based on a relationship among the plurality of agents;
select, for the first agent, a true value or an alternative value as a value to be input to a first policy parameter according to the priority of the state;
determine, for the first agent, a first degree of influence on a constraint condition of the first agent and a third degree of influence on system-wide constraint conditions based on a second degree of influence by a second policy parameter updated by a second agent in a previous order in an update order according to a predetermined update order by using the first policy parameter to which the value is input; and
determine a range of a policy parameter that satisfies the constraint condition according to the first degree of influence and the third degree of influence.

7. A learning method for causing a computer to execute processing comprising:
in a constrained control problem in which a plurality of agents exist,
determining priority of a state to be used at a time of making an action for a first agent among the plurality of agents based on a relationship among the plurality of agents;
selecting, for the first agent, a true value or an alternative value as a value to be input to a first policy parameter according to the priority of the state;
determining, for the first agent, a first degree of influence on a constraint condition of the first agent and a third degree of influence on system-wide constraint conditions based on a second degree of influence by a second policy parameter updated by a second agent in a previous order in an update order according to a predetermined update order by using the first policy parameter to which the value is input; and
determining a range of a policy parameter that satisfies the constraint condition according to the first degree of influence and the third degree of influence.
